(19) United States
(12) Patent Application Publication
(10) Pub. No.: US 2024/0314220 A1
(43) Pub. Date: Sep. 19, 2024

(54) WIRELESS COMMUNICATION METHOD AND COMMUNICATION DEVICE

(71) Applicant: GUANGDONG OPPO MOBILE TELECOMMUNICATIONS CORP., LTD., Dongguan (CN)

(72) Inventors: Zhe FU, Dongguan (CN); Qianxi LU, Dongguan (CN)

(21) Appl. No.: 18/673,027

(22) Filed: May 23, 2024

Related U.S. Application Data
(63) Continuation of application No. PCT/CN2021/137256, filed on Dec. 10, 2021.

(51) Int. Cl. H04L 69/04; H04L 69/22; H04L 69/324; H04W 28/06

(52) U.S. Cl. CPC H04L 69/04; H04L 69/22; H04L 69/324; H04W 28/06

(57) ABSTRACT

A wireless communication method includes: performing a compression operation on a first data packet based on at least one compression protocol; where the at least one compression protocol includes a UDC protocol.

### CROSS-REFERENCE TO RELATED APPLICATION

This application is a continuation of International Application No. PCT/CN2021/137256 filed on Dec. 10, 2021, which is incorporated herein by reference in its entirety.

### TECHNICAL FIELD

Embodiments of the present application relate to the field of communication, and in particular, to a wireless communication method and a communication device.

### BACKGROUND

Up to now, a New Radio (NR) system may support compression of a header of a data packet. A compression technology for compressing the header of the data packet may include Robust header compression (ROHC) and Ethernet frame header compression (EHC). However, the NR system does not support compression for a data portion, nor does it support compression for both the header and the data portion. Therefore, a wireless communication method is urgently needed in this filed, which can implement the compression of the data packet header, thereby improving system performance.

### SUMMARY

Embodiments of the present application provide a wireless communication method and communication device.

In a first aspect, the present application provides a wireless communication method, including:
performing a compression or decompression operation on a first data packet based on at least one compression protocol, where the at least one compression protocol includes an uplink data compression (UDC) protocol.

In a second aspect, the present application provides a communication device for performing the method in the above first aspect or its various implementations. In some implementations, the communication device includes functional modules for executing the method in the above first aspect or its various implementations.

In an implementation, the communication device may include a processing unit configured to perform functions related to information processing. For example, the processing unit may be a processor.

In an implementation, the communication device may include a transmitting unit and/or a receiving unit. The transmitting unit is configured to perform functions related to transmitting, and the receiving unit is configured to perform functions related to receiving. For example, the transmitting unit may be a transmitter, and the receiving unit may be a receiver. For another example, the communication device is a communication chip, the receiving unit may be an input circuit or interface of the communication chip, and the transmitting unit may be an output circuit or interface of the communication chip.

In some implementations, the communication device may be a terminal device or a network device.

In a third aspect, the present application provides a communication device, including a memory and a processor. The memory is configured to store a computer program, and the processor is configured to invoke and execute the computer program stored in the memory to perform the method in the above first aspect or its various implementations.

In an implementation, there are one or more processors and one or more memories.

In an implementation, the memory may be integrated with the processor, or the memory is provided separately from the processor.

In an implementation, the communication device also includes a transmitter and a receiver.

In some implementations, the communication device may be a terminal device or a network device.

In a fourth aspect, the present application provides a chip for implementing the method in the above first aspect or its various implementations. In some implementations, the chip includes: a processor, configured to invoke and execute a computer program from a memory, causing a device installed with the chip to perform the method in the above first aspect or its various implementations.

In a fifth aspect, the present application provides a non-transitory computer readable storage medium storing a computer program, where the computer program causes a computer to perform the method in the above first aspect or its various implementations.

In a sixth aspect, the present application provides a computer program product, including computer program instructions, which cause a computer to perform the method in the above first aspect or its various implementations.

In a seventh aspect, the present application provides a computer program that, when executed on a computer, causes the computer to perform the method in the above first aspect or its various implementations.

### BRIEF DESCRIPTION OF THE DRAWINGS

FIG. 1 is an example of a system framework of the embodiments of the present application;

FIG. 2 is a schematic diagram of a compressed packet formed by compressing a data packet header based on an ROHC protocol and an EHC protocol, provided by the embodiments of the present application.

FIG. 3 is a schematic flowchart of a wireless communication method, provided by the embodiments of the present application.

FIG. 4 is a schematic diagram of a compressed packet formed by compressing an SDAP control PDU, provided by the embodiments of the present application.

FIGS. 5A to 5D are schematic diagrams of a compressed packet formed by performing a compression operation on a first data packet based on at least one of an EHC protocol, an ROHC protocol, or a UDC protocol, provided by the embodiments of the present application.

FIGS. 6A to 6C are schematic diagrams of a compressed packet formed by performing a compression operation on a first data packet based on at least one of an EHC protocol or a UDC protocol, provided by the embodiments of the present application.

FIGS. 7A to 7E are schematic diagrams of a compressed packet formed by performing a compression operation on a first data packet based on at least one of an ROHC protocol or a UDC protocol, provided by the embodiments of the present application.

FIGS. 8A to 8B are schematic diagrams of a compressed packet formed by performing a compression operation on a first data packet based on a UDC protocol, provided by the embodiments of the present application.

FIG. 9 is a schematic block diagram of a communication device, provided by the embodiments of the present application.

FIG. 10 is another schematic block diagram of a communication device, provided by the embodiments of the present application.

FIG. 11 is a schematic block diagram of a chip, provided by the embodiments of the present application.

### DETAILED DESCRIPTION

The technical solutions in the embodiments of the present application will be described with reference to the accompanying drawings.

In the embodiments, a wireless communication method is provided, which includes:
performing a compression or decompression operation on a first data packet based on at least one compression protocol, where the at least one compression protocol includes an uplink data compression (UDC) protocol.

In some embodiments, the at least one compression protocol further includes at least one of the following protocols: an Ethernet frame header compression (EHC) protocol, or a robust header compression (ROHC) protocol.

In some embodiments, a service data adaptation protocol (SDAP) header in the first data packet is not compressed; and/or, when the first data packet is an SDAP control protocol data unit (PDU), the SDAP control PDU is not compressed.

In some embodiments, an SDAP header in the first data packet is compressed; and/or, when the first data packet is an SDAP control protocol data unit (PDU), the SDAP control PDU is compressed.

In some embodiments, performing the compression or decompression operation on the first data packet based on the at least one compression protocol, includes:
based on the UDC protocol, performing the compression or decompression operation on the SDAP header in the first data packet.

In some embodiments, performing the compression or decompression operation on the first data packet based on the at least one compression protocol, includes:
when the first data packet is the SDAP control PDU, performing the compression or decompression operation on the first data packet as a whole based on the UDC protocol.

In some embodiments, the first data packet or a compressed packet of the first data packet includes a packet data convergence protocol (PDCP) header, a UDC header and a data block in sequence.

In some embodiments, performing the compression or decompression operation on the first data packet as a whole based on the UDC protocol, includes:
when at least one of the following is met, performing the compression or decompression operation on the first data packet as a whole based on the UDC protocol:
the compression or decompression operation being performed on the SDAP header;
the compression or decompression operation being performed on the SDAP control PDU;
UDC configuration being configured;
the UDC configuration and ROHC configuration being configured;
the UDC configuration and EHC configuration being configured;
the UDC configuration, the EHC configuration and the ROHC configuration being configured;
the UDC configuration and the ROHC configuration being configured not simultaneously;
the UDC configuration and the EHC configuration being configured not simultaneously;
first indication information being indicated or configured, where the first indication information is used to indicate whether to perform the compression or decompression operation on the SDAP header and/or the SDAP control PDU;
second indication information being indicated or configured, where the second indication information is used to indicate a filed or information of performing a UDC compression or decompression operation;
a predefined rule indicating that the compression or decompression operation is not performed on the SDAP header and/or the SDAP control PDU; or
a predefined rule indicating that the compression or decompression operation is performed on the SDAP header and/or the SDAP control PDU.

In some embodiments, the first data packet is a PDCP PDU or a PDCP service data unit (SDU).

In some embodiments, the UDC protocol is used to compress at least one of: an SDAP header, an Ethernet frame header, an IP header, a payload, a remaining portion of the first data packet except a packet header, or an uncompressed remaining portion of the first data packet.

In some embodiments, an EHC protocol in the at least one compression protocol is used to compress an Ethernet frame header; and/or, an ROHC protocol in the at least one compression protocol is used to compress an Internet protocol (IP) header; and/or, the UDC protocol is used to compress a payload and/or an uncompressed remaining portion of the first data packet.

In some embodiments, the uncompressed remaining portion of the first data packet includes: an uncompressed remaining portion of the first data packet except a packet header.

In some embodiments, the first data packet or a compressed packet of the first data packet includes at least one of: a PDCP header, an SDAP header, an EHC header, an ROHC header, a UDC header and a data block.

In some embodiments, performing the compression or decompression operation on the first data packet based on the at least one compression protocol, includes:
performing the compression or decompression operation on the first data packet based on at least one of the EHC protocol, the ROHC protocol or the UDC protocol.

In some embodiments, performing the compression or decompression operation on the first data packet based on at least one of the EHC protocol, the ROHC protocol or the UDC protocol, includes:
when at least one of the following is met, performing the compression or decompression operation on the first data packet based on at least one of the EHC protocol, the ROHC protocol, or the UDC protocol:
UDC configuration, EHC configuration and ROHC configuration being configured;
the UDC configuration and the ROHC configuration being configured simultaneously;
the UDC configuration and the EHC configuration being configured simultaneously; or
the first data packet comprising at least one of the Ethernet frame header, the IP header, or the payload.

In some embodiments, performing the compression or decompression operation on the first data packet based on at least one of the EHC protocol, the ROHC protocol or the UDC protocol, includes:
when the compression or decompression operation is not performed on a service data adaptation protocol (SDAP) header in the first data packet, performing the compression or decompression operation on the first data packet based on the EHC protocol, the ROHC protocol and the UDC protocol in sequence;
where the first data packet or a compressed packet of the first data packet includes at least one of the following in sequence: a PDCP header, an SDAP header, an EHC header, an ROHC header, a UDC header or a data block.

In some embodiments, performing the compression or decompression operation on the first data packet based on at least one of the EHC protocol, the ROHC protocol or the UDC protocol, includes:
when the compression or decompression operation is performed on a service data adaptation protocol (SDAP) header in the first data packet, after performing the compression or decompression operation on the SDAP header based on the UDC protocol, performing the compression or decompression operation on the first data packet based on the EHC protocol, the ROHC protocol and the UDC protocol in sequence;
where the first data packet or a compressed packet of the first data packet includes at least one of the following in sequence: a PDCP header, a first UDC header, an EHC header, an ROHC header, a second UDC header, or a data block.

In some embodiments, the first UDC header includes a data block.

In some embodiments, performing the compression or decompression operation on the first data packet based on at least one of the EHC protocol, the ROHC protocol or the UDC protocol, includes:
when the compression or decompression operation is performed on a service data adaptation protocol (SDAP) header in the first data packet, performing the compression or decompression operation on the first data packet based on the EHC protocol, the ROHC protocol and the UDC protocol in sequence;
where the first data packet or a compressed packet of the first data packet includes at least one of the following in sequence: a PDCP header, an EHC header, an ROHC header, a UDC header or a data block.

In some embodiments, performing the compression or decompression operation on the first data packet based on at least one of the EHC protocol, the ROHC protocol or the UDC protocol, includes:
when the compression or decompression operation is performed on a service data adaptation protocol (SDAP) header in the first data packet, performing the compression or decompression operation on the first data packet based on the ROHC protocol, the EHC protocol and the UDC protocol in sequence;
where the first data packet or a compressed packet of the first data packet includes at least one of the following in sequence: a PDCP header, an ROHC header, an EHC header, a UDC header or a data block.

In some embodiments, an EHC protocol in the at least one compression protocol is used to compress an Ethernet frame header; and/or, the UDC protocol is used to compress at least one of: a payload, an Internet protocol (IP) header, or a remaining portion of the first data packet except a packet header.

In some embodiments, the first data packet or a compressed packet of the first data includes at least one of: a PDCP header, an SDAP header, an EHC header, a UDC header or a data block.

In some embodiments, performing the compression or decompression operation on the first data packet based on the at least one compression protocol, includes:
performing the compression or decompression operation on the first data packet based on at least one of the EHC protocol or the UDC protocol.

In some embodiments, performing the compression or decompression operation on the first data packet based on at least one of the EHC protocol or the UDC protocol, includes:
when at least one of the following is met, performing the compression or decompression operation on the first data packet based on at least one of the EHC protocol or the UDC protocol:
the first data packet being a non-IP Ethernet frame packet;
the compression or decompression operation being performed on an IP header in the first data packet based on the UDC protocol; UDC configuration and EHC configuration being configured;
the UDC configuration, the EHC configuration and ROHC configuration being configured;
the UDC configuration and the ROHC configuration being configured not simultaneously;
the first data packet comprising at least one of the Ethernet frame header, the IP header, or the payload.

In some embodiments, performing the compression or decompression operation on the first data packet based on at least one of the EHC protocol or the UDC protocol, includes:
when the compression or decompression operation is not performed on a service data adaptation protocol (SDAP) header in the first data packet, performing the compression or decompression operation on the first data packet based on the EHC protocol and the UDC protocol in sequence;
where the first data packet or a compressed packet of the first data packet includes at least one of the following in sequence: a PDCP header, an SDAP header, an EHC header, a UDC header or a data block.

In some embodiments, performing the compression or decompression operation on the first data packet based on at least one of the EHC protocol or the UDC protocol, includes:
when the compression or decompression operation is performed on a service data adaptation protocol (SDAP) header in the first data packet, after performing the compression or decompression operation on the SDAP header based on the UDC protocol, performing the compression or decompression operation on the first data packet based on the EHC protocol and the UDC protocol in sequence;
where the first data packet or a compressed packet of the first data packet includes at least one of the following in sequence: a PDCP header, a third UDC header, an EHC header, a fourth UDC header, or a data block.

In some embodiments, the third UDC header includes a data block.

In some embodiments, performing the compression or decompression operation on the first data packet based on at least one of the EHC protocol or the UDC protocol, includes:
when the compression or decompression operation is performed on a service data adaptation protocol (SDAP) header in the first data packet, performing the compression or decompression operation on the first data packet based on the EHC protocol and the UDC protocol in sequence;
where the first data packet or a compressed packet of the first data packet includes at least one of the following in sequence: a PDCP header, an EHC header, a UDC header, or a data block.

In some embodiments, an ROHC protocol in the at least one compression protocol is used to compress an Internet protocol (TP) header; and/or, the UDC protocol is used to compress at least one of: a payload, an Ethernet frame header, or a remaining portion of the first data packet except a packet header.

In some embodiments, the first data packet or a compressed packet of the first data includes at least one of: a PDCP header, an SDAP header, an ROHC header, a UDC header or a data block.

In some embodiments, performing the compression or decompression operation on the first data packet based on the at least one compression protocol, includes:
performing the compression or decompression operation on the first data packet based on at least one of the ROHC protocol or the UDC protocol.

In some embodiments, performing the compression or decompression operation on the first data packet based on at least one of the ROHC protocol or the UDC protocol, includes:
when at least one of the following is met, performing the compression or decompression operation on the first data packet based on at least one of the ROHC protocol or the UDC protocol:
the first data packet being an IP packet;
the first data packet being a non-Ethernet frame packet;
the compression or decompression operation being performed on an IP header in the first data packet based on the UDC protocol;
UDC configuration and ROHC configuration being configured;
the UDC configuration, the ROHC configuration and EHC configuration being configured;
the UDC configuration and the EHC configuration being configured not simultaneously; or
the first data packet comprising at least one of the Ethernet frame header, the IP header, or the payload.

In some embodiments, performing the compression or decompression operation on the first data packet based on at least one of the ROHC protocol or the UDC protocol, includes:
when the compression or decompression operation is not performed on a service data adaptation protocol (SDAP) header in the first data packet, performing the compression or decompression operation on the first data packet based on the ROHC protocol and the UDC protocol in sequence;
where the first data packet or a compressed packet of the first data packet includes at least one of the following in sequence: a PDCP header, an SDAP header, an ROHC header, a UDC header or a data block.

In some embodiments, performing the compression or decompression operation on the first data packet based on at least one of the ROHC protocol or the UDC protocol, includes:
when the first data packet is an Ethernet frame packet, and the compression or decompression operation is not performed on a service data adaptation protocol (SDAP) header in the first data packet, after performing the compression or decompression operation on the Ethernet frame header in the first data packet based on the UDC protocol, performing the compression or decompression operation on the first data packet based on the ROHC protocol and the UDC protocol in sequence;
where the first data packet or a compressed packet of the first data packet includes at least one of the following in sequence: a PDCP header, an SDAP header, a fifth UDC header, an ROHC header, a sixth UDC header, or a data block.

In some embodiments, the fifth UDC header includes a data block.

In some embodiments, performing the compression or decompression operation on the first data packet based on at least one of the ROHC protocol or the UDC protocol, includes:
when the first data packet is an Ethernet frame packet, and the compression or decompression operation is not performed on a service data adaptation protocol (SDAP) header in the first data packet, performing the compression or decompression operation on the first data packet based on the ROHC protocol and the UDC protocol in sequence;
where the first data packet or a compressed packet of the first data packet includes at least one of the following in sequence: a PDCP header, an SDAP header, an ROHC header, a UDC header or a data block.

In some embodiments, performing the compression or decompression operation on the first data packet based on at least one of the ROHC protocol or the UDC protocol, includes:
when the compression or decompression operation is performed on a service data adaptation protocol (SDAP) header in the first data packet, after performing the compression or decompression operation on the SDAP header based on the UDC protocol, performing the compression or decompression operation on the first data packet based on the ROHC protocol and the UDC protocol in sequence;
where the first data packet or a compressed packet of the first data packet includes at least one of the following in sequence: a PDCP header, a seventh UDC header, an ROHC header, an eighth UDC header, or a data block.

In some embodiments, the seventh UDC header includes a data block.

In some embodiments, performing the compression or decompression operation on the first data packet based on at least one of the ROHC protocol or the UDC protocol, includes:
when the first data packet is an Ethernet frame packet, and the compression or decompression operation is performed on a service data adaptation protocol (SDAP) header in the first data packet, after performing the compression or decompression operation on the SDAP header and the Ethernet frame header in the first data packet based on the UDC protocol, performing the compression or decompression operation on the first data packet based on the ROHC protocol and the UDC protocol in sequence;
where the first data packet or a compressed packet of the first data packet includes at least one of the following in sequence: a PDCP header, a ninth UDC header, an ROHC header, a tenth UDC header, or a data block.

In some embodiments, the ninth UDC header includes a data block.

In some embodiments, performing the compression or decompression operation on the first data packet based on at least one of the ROHC protocol or the UDC protocol, includes:
when the first data packet is an Ethernet frame packet, and the compression or decompression operation is performed on a service data adaptation protocol (SDAP) header in the first data packet, performing the compression or decompression operation on the first data packet based on the ROHC protocol and the UDC protocol in sequence;
where the first data packet or a compressed packet of the first data packet includes at least one of the following in sequence: a PDCP header, an ROHC header, a UDC header or a data block.

In some embodiments, the UDC protocol is used to compress at least one of: an Internet protocol (TP) header, a payload, an Ethernet frame header, or a remaining portion of the first data packet except a packet header.

In some embodiments, the first data packet or a compressed packet of the first data packet includes at least one of: a PDCP header, an SDAP header, or a UDC header and a data block.

In some embodiments, the packet header includes at least one of: a PDCP header, an SDAP header, an Ethernet frame header, or an IP header.

In some embodiments, performing the compression or decompression operation on the first data packet based on the at least one compression protocol, includes:
performing the compression or decompression operation on the first data packet based on the UDC protocol.

In some embodiments, performing the compression or decompression operation on the first data packet based on the UDC protocol, includes:
when at least one of the following is met, performing the compression or decompression operation on the first data packet based on the UDC protocol:
the compression or decompression operation being performed on the Ethernet frame header, the IP header and a data portion in the first data packet based on the UDC protocol;
the compression or decompression operation being performed on the data portion in the first data packet based on the UDC protocol;
the first data packet being an IP packet;
the first data packet being an Ethernet frame packet; UDC configuration being configured;
the UDC configuration and ROHC configuration being configured;
the UDC configuration and EHC configuration being configured;
the UDC configuration, the EHC configuration and the ROHC configuration being configured;
the UDC configuration and the ROHC configuration being configured not simultaneously;
the UDC configuration and the EHC configuration being configured not simultaneously; or
the first data packet comprising at least one of the Ethernet frame header, the IP header, or the payload.

In some embodiments, performing the compression or decompression operation on the first data packet based on the UDC protocol, includes:
when the compression or decompression operation is not performed on a service data adaptation protocol (SDAP) header in the first data packet, performing the compression or decompression operation on the first data packet based on the UDC protocol;
where the first data packet or a compressed packet of the first data packet includes at least one of the following in sequence: a PDCP header, an SDAP header, a UDC header, or a data block.

In some embodiments, performing the compression or decompression operation on the first data packet based on the UDC protocol, includes:
when the compression or decompression operation is performed on a service data adaptation protocol (SDAP) header in the first data packet, performing the compression or decompression operation on the first data packet based on the UDC protocol;
where the first data packet or a compressed packet of the first data packet includes at least one of the following in sequence: a PDCP header, a UDC header or a data block.

In some embodiments, the first data packet or a compressed packet of the first data packet includes third indication information, and the third indication information is used to indicate at least one of:
whether an SDAP header is compressed;
a number of bits occupied by the SDAP header or a number of bits occupied by a compressed SDAP header; or
a starting position or an ending position occupied by the compressed SDAP header.

In some embodiments, the third indication information is carried in a PDCP PDU or a UDC PDU or a UDC header.

In some embodiments, the first data packet or a compressed packet of the first data packet includes fourth indication information, and the fourth indication information is used to indicate at least one of:
whether an Ethernet frame header is compressed;
a number of bits occupied by the Ethernet frame header or a number of bits occupied by a compressed Ethernet frame header; or
a starting position or an ending position occupied by the compressed Ethernet frame header.

In some embodiments, the fourth indication information is carried in a PDCP PDU or a UDC PDU or a UDC header.

In some embodiments, the first data packet or a compressed packet of the first data packet includes fifth indication information, and the fifth indication information is used to indicate at least one of:
whether an IP header is compressed;
a number of bits occupied by the IP header or a number of bits occupied by a compressed IP header; or
a starting position or an ending position occupied by the compressed IP header.

In some embodiments, the fifth indication information is carried in a PDCP PDU or a UDC PDU or a UDC header.

In some embodiments, the first data packet or a compressed packet of the first data packet includes sixth indication information, and the sixth indication information is used to indicate whether to bypass an IP protocol and/or an ROHC protocol.

In some embodiments, the sixth indication information is carried in a PDCP PDU or a UDC PDU or a UDC header.

In some embodiments, the first data packet or a compressed packet of the first data packet includes seventh indication information, and the seventh indication information is used to indicate whether to bypass an Ethernet frame protocol and/or an EHC protocol.

In some embodiments, the seventh indication information is carried in a PDCP PDU or a UDC PDU or a UDC header.

In some embodiments, the method further includes:
receiving or transmitting UDC configuration, where the UDC configuration meets at least one of:
both a network device and a terminal device being entities that support a new radio (NR) version;
the network device being a base station in an NR system;
the UDC configuration being configured for a data radio bearer (DRB) and/or the terminal device;
the UDC configuration being carried in packet data convergence protocol (PDCP) configuration;
the UDC configuration being carried in bearer configuration;
the UDC configuration comprising at least one of a buffer size or a dictionary;
the UDC configuration being configured simultaneously with at least one of the following configuration: EHC configuration, or ROHC configuration;
the UDC configuration being configured not simultaneously with at least one of the following configuration: EHC configuration, or ROHC configuration;
the UDC configuration being configured not simultaneously with at least one of the following configuration: dual active protocol stack (DAPS) configuration, control handover (CHO) configuration, out-of-order transmission configuration, repetition configuration, or furcation transmission configuration;
the UDC configuration being configured simultaneously with at least one of the following configuration: DAPS configuration, repetition configuration, or furcation transmission configuration;
radio resource control (RRC) configuration, PDCP configuration, DAPS configuration or the UDC configuration comprising eighth indication information, and the eighth indication information being used to indicate whether a dual active protocol stack handover (DAPS HO) supports the UDC configuration;
the RRC configuration, the PDCP configuration, the DAPS configuration or the UDC configuration comprising ninth indication information, and the ninth indication information being used to indicate whether to continue to use the UDC configuration, or to indicate whether to continue to use the UDC configuration when PDCP reestablishment is performed;
a radio link control (RLC) mode corresponding to the UDC configuration being an acknowledged mode (AM);
a RLC mode corresponding to the UDC configuration being a bi-directional unacknowledged mode (UM); or
the UDC configuration or a field corresponding to the UDC configuration being configured for a bi-directional data radio bearer (DRB).

In some embodiments, the UDC configuration is configured when PDCP reestablishment configuration is configured, and/or, the UDC configuration is configured when the ninth indication information is not configured.

In some embodiments, the radio link control (RLC) mode corresponding to the UDC configuration being the acknowledged mode (AM), includes: the RLC mode corresponding to at least one of the following corresponding to the UDC configuration being the acknowledged mode (AM): a bearer, a logical channel, or RLC.

In some embodiments, the RLC mode corresponding to the UDC configuration being the bi-directional unacknowledged mode (UM), includes: the RLC mode corresponding to at least one of the following corresponding to the UDC configuration being the bi-directional unacknowledged mode (UM): a bearer, a logical channel, or RLC.

In some embodiments, when configuration information of DAPS is configured for the terminal device, the RRC configuration, the PDCP configuration, the DAPS configuration or the UDC configuration includes the eighth indication information.

In some embodiments, the ninth indication information is configured in a case of a radio resource control (RRC) connection being resumed or handover.

In some embodiments, a configured PDCP entity remains unchanged and does not indicate full configuration.

In some embodiments, when a configured bearer is a DAPS bearer, the ninth indication information is not configured.

In some embodiments, the eighth indication information is used to indicate that the DAPS HO supports the UDC configuration.

In some embodiments, at least one of a UDC buffer, a UDC synchronization state, or UDC context information corresponding to the UDC configuration is transmitted by a source network device to a target network device or is transmitted by the terminal device to the target network device.

In some embodiments, the at least one of the UDC buffer, the UDC synchronization state, or the UDC context information corresponding to the UDC configuration being transmitted by the source network device to the target network device or being transmitted by the terminal device to the target network device, includes: when the ninth indication information is used to indicate to continue to use the UDC configuration when the PDCP reestablishment is performed, the at least one of the UDC buffer, the UDC synchronization state, or the UDC context information corresponding to the UDC configuration being transmitted by the source network device to the target network device or is transmitted by the terminal device to the target network device.

In some embodiments, the UDC configuration between the terminal device and a source network device is used before uplink handover in a case of performing the DAPS HO; and/or, the UDC configuration configured by the source network device is used before uplink handover in a case of performing the DAPS HO.

In some embodiments, the UDC configuration between the terminal device and a target network device is used after uplink handover; and/or, the UDC configuration configured by a source network device is used after uplink handover; and/or, the UDC configuration configured by the target network device is used after uplink handover.

In some embodiments, the eighth indication information is used to indicate not to continue to use the UDC configuration; and/or, the eighth indication information is used to indicate not to continue to use the UDC configuration when the PDCP reestablishment is performed; and/or, the eighth indication information is not carried in the RRC configuration, the PDCP configuration, the DAPS configuration or the UDC configuration.

In some embodiments, the method further includes:
performing at least one of:
resetting a compression buffer to all zeros or a pre-defined dictionary;
decompressing all stored PDCP service data units (SDUs) by using the UDC configuration; or
after decompressing all the stored PDCP SDUs by using the UDC configuration, resetting the compression buffer to all zeros or the pre-defined dictionary.

In some embodiments, performing the at least one of the following, includes:
in a case where a first condition is met, performing at least one of:
resetting the compression buffer to all zeros or the pre-defined dictionary;
decompressing all the stored PDCP service data units (SDUs) by using the UDC configuration; or
after decompressing all the stored PDCP SDUs by using the UDC configuration, resetting the compression buffer to all zeros or the pre-defined dictionary;
where the first condition includes at least one of:
being in a process of performing the DAPS HO;
being in a process of performing the DAPS HO and the eighth indication information being used to indicate that the DAPS HO does not support the UDC configuration;
being in a process of performing the DAPS HO and the ninth indication information being used to indicate not to continue to use the UDC configuration or to indicate not to continue to use the UDC configuration when the PDCP reestablishment is performed; or
being in a process of performing uplink handover.

In some embodiments, the eighth indication information is used to indicate to continue to use the UDC configuration when the PDCP reestablishment is performed; and/or, the eighth indication information is carried in the RRC configuration, the PDCP configuration, the DAPS configuration or the UDC configuration.

In some embodiments, the method further includes:
continuing to use a buffer of the UDC configuration without resetting the buffer.

In some embodiments, the method further includes:
receiving or transmitting at least one of the following configuration: ROHC configuration, or EHC configuration.

In some embodiments, the method is applicable for a terminal device or a network device.

In some embodiments, performing the compression operation on the first data packet based on the at least one compression protocol, includes:
performing the compression operation based on the UDC protocol, and generating a UDC packet; where the UDC packet comprises a UDC header and a UDC data block.

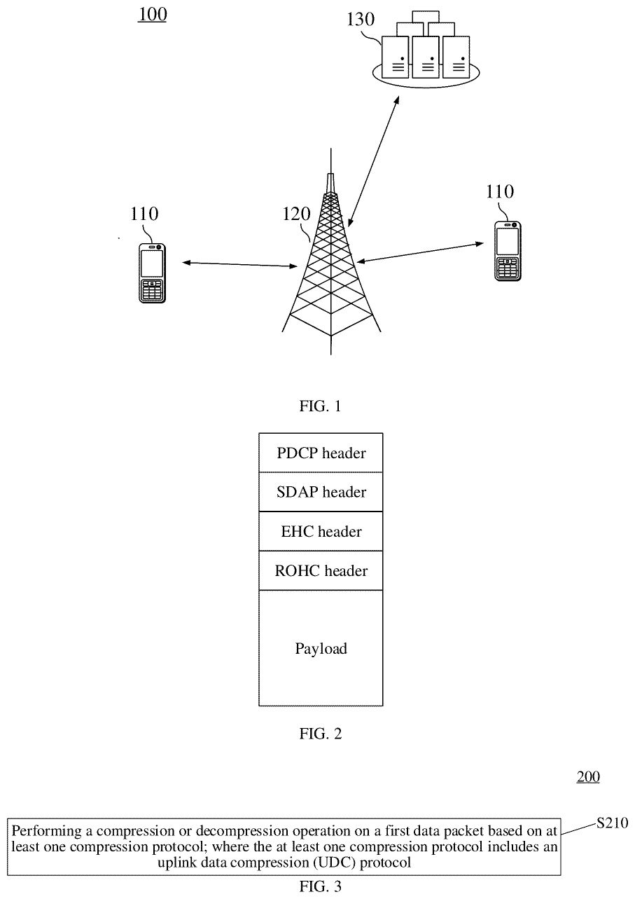

FIG. 1 is an example of a system framework of the embodiments of the present application.

As shown in FIG. 1, a communication system 100 may include a terminal device 110 and a network device 120. The network device 120 may communicate with the terminal device 110 through a new radio. Multi-service transmission is supported between the terminal device 110 and the network device 120.

It should be understood that the embodiments of the present application are illustrated exemplarily only with the communication system 100, but the embodiments of the present application are not limited thereto. That is to say, the technical solutions of the embodiments of the present application may be applied to various communication systems, such as: a Long Term Evolution (LTE) system, an LTE Time Division Duplex (TDD), a Universal Mobile Telecommunication System (UMTS), an Internet of Things (IoT) system, a Narrow Band Internet of Things (NB-IoT) system, an enhanced Machine-Type Communications (eMTC) system, a 5G communication system (also called as a New Radio (NR) communication system), or a future communication system, etc.

In the communication system 100 shown in FIG. 1, the network device 120 may be an access network device that communicates with the terminal device 110. The access network device may provide communication coverage for a specific geographical area and may communicate with the terminal device 110 (eg, ULE) located within a coverage area.

The network device 120 may be an evolutional base station (Evolutional Node B, eNB or eNodeB) in the Long Term Evolution (LTE) system, or a Next Generation Radio Access Network (NG RAN) device, or a base station (gNB) in the NR system, or a wireless controller in a Cloud Radio Access Network (CRAN), or the network device 120 may be a relay station, an access point, an in-vehicle device, or a wearable device, a hub, a switch, a network bridge, a router, or a network device in a future evolved Public Land Mobile Network (PLMN), etc.

The terminal device 110 may be any terminal device, including but not limited to a terminal device that employs a wired or wireless connection with the network device 120 or other terminal devices.

For example, the terminal device 110 may also refers to an access terminal, a user equipment (UE), a user unit, a user station, a mobile station, a mobile platform, a remote station, a remote terminal, a mobile device, a user terminal, terminal, a wireless communication device, a user agent, or a user apparatus, etc. The access terminal may be a cellular phone, a cordless phone, a Session Initiation Protocol (SIP) phone, an IoT device, a satellite handheld terminal, a Wireless Local Loop (WLL) station, or a Personal Digital Assistant (PDA), a handheld device with a wireless communication function, a computing device or other processing devices connected to a wireless modem, an in-vehicle device, a wearable device, a terminal device in a 5G network or a terminal device in a future evolution network, etc.

The terminal device 110 may be used for communication of device-to-device (Device to Device, D2D).

The wireless communication system 100 may also include a core network device 130 that communicates with the base station, and the core network device 130 may be a 5G core network (5G Core, 5GC) device, for example, an Access and Mobility Management Function (AMF), for another example, Authentication Server Function (AUSF), for another example, User Plane Function (UPF), for another example, Session Management Function (SMF). Optionally, the core network device 130 may also be an Evolved Packet Core (EPC) device of an LTE network, for example, a Session Management Function+Core Packet Gateway (SMF+PGW-C) device. It should be understood that the SMF+PGW-C may simultaneously implement functions that SMF and PGW-C can implement. In a process of network evolution, the above core network device may also be called as other names, or form new network entities by dividing functions of the core network, which is not limited by the embodiments of the present application.

Connections between various functional units in the communication system 100 may also be established through a next generation (NG) interface to implement communication.

For example, the terminal device establishes a new radio connection with the access network device through a NR interface, for transmitting user plane data and control plane signaling; the terminal device may establish a control plane signaling connection with the AMF through a NG interface 1 (called as N1 for short); the access network device, such as a next generation wireless access base station (gNB), may establish a user plane data connection with the UPF through a NG interface 3 (called as N3 for short); the access network device may establish a control plane signaling connection with the AMF through a NG interface 2 (called as N2 for short); the UPF may establish a control plane signaling connection with the SMF through a NG interface 4 (called as N4 for short); the UPF may exchange user plane data with a data network through a NG interface 6 (called as N6 for short); the AMF may establish a control plane signaling connection with the SMF through a NG interface 11 (called as N11 for short); the SMF may establish a control plane signaling connection with a PCF (Policy Control Function) through a NG interface 7 (called as N7 for short).

FIG. 1 exemplarily shows one base station, one core network device and two terminal devices. Optionally, the wireless communication system 100 may include multiple base station devices and may include other number of terminal devices within coverage range of each base station, the embodiments of the present application are not limited thereto.

It should be understood that, in the embodiments of the present application, each device with a communication function in the network/system may be called as a communication device. Taking the communication system 100 shown in FIG. 1 as an example, the communication device may include the network device 120 and the terminal device 110 with communication functions; the network device 120 and the terminal device 110 may be the devices described above, which will not be repeated here; the communication device may also include other devices in the communication system 100, such as a network controller, a mobility management entity and other network entities, which are not limited in the embodiments of the present application.

It should be understood that, the terms herein “system” and “network” are often used interchangeably herein. The term herein “and/or” is only an association relationship to describe associated objects, meaning that there may be three kinds of relationships, for example, A and/or B may mean three cases where: A exists alone, both A and B exist, and B exists alone. In addition, a character “/” herein generally means that related objects before and after “/” are in an “or” relationship.

It should also be understood that, “corresponding” mentioned in the embodiments of the present application may mean that there is a direct correspondence or indirect correspondence between the two, it may also mean that there is an associated relationship between the two, or it may also mean a relationship of indicating and being indicated or a relationship of configuring and being configured, etc. It should also be understood that, “predefined” or “a predefined rule” mentioned in the embodiments of the present application may be implemented by pre-saving corresponding codes, tables or other manners that may be used for indicating related information, in the device (for example, including the terminal device and the network device), and the present application does not limit its implementations. For example, the predefined may refer to what is defined in a protocol. It should further be understood that, in the embodiments of the present application, the “protocol” may refer to a standard protocol in the field of communication, which may include, for example, an LTE protocol, an NR protocol, and related protocols applied in the future communication system, and the present application is not limited thereto.

FIG. 2 is a schematic diagram of a compressed packet formed by compressing a header of a data packet based on an ROHC protocol and an EHC protocol, provided by the embodiments of the present application.

As shown in FIG. 2, the compressed packet formed by compressing the data packet based on the ROHC protocol and the EHC protocol includes at least one of the following in sequence: a PDCP header, an SDAP header, an EHC header, an ROHC header, or a payload. Herein, ROHC compresses an IP header, EHC compresses an Ethernet frame header. Their compression configuration and execution are performed for a DRB.

However, since the ROHC protocol and the EHC protocol are compression technologies for the packet header, that is, the ROHC protocol and the EHC protocol do not support compression for data portion, nor compression of both the header and the data portion. In view of this, the embodiments of the present application provide a wireless communication method and a communication device, which can implement a compression or decompression operation on the data packet header, thereby improving system performance.

FIG. 3 is a schematic flowchart of a wireless communication method 200, provided by the embodiments of the present application. The wireless communication method 200 may be performed by a communication device, and the communication device may be a terminal device or a network device, the terminal device as shown in FIG. 1 or the access network device as shown in FIG. 1.

As shown in FIG. 3, the method 200 may include:
S210, performing a compression or decompression operation on a first data packet based on at least one compression protocol; where the at least one compression protocol includes an uplink data compression (UDC) protocol.

Exemplarily, when the communication device performs the compression operation based on the UDC protocol, a UDC packet may be generated, and the UDC packet may include a UDC header and a UDC data block. When the communication device performs the decompression operation based on the UDC protocol, the communication device performs the decompression operation on a received UDC packet based on the UDC protocol.

In this embodiment, by introducing the uplink data compression (UDC) protocol and performing the compression or decompression operation on the first data packet based on at least one compression protocol including the UDC protocol, the compression or decompression operation on the data packet header can be implemented, thereby improving system performance. In some implementations, performing the compression or decompression operation on the first data packet based on at least one compression protocol including the UDC protocol can save UL resources and reduce transmission delay.

Exemplarily, when the first data packet is a to-be-compressed data packet, the communication device performs the compression operation on the first data packet based on the at least one compression protocol; when the first data packet is a compressed data packet, the communication device may perform the decompression operation on the first data packet based on the at least one compression protocol.

Exemplarily, the first data packet may be a Packet Data Convergence Protocol (PDCP) Protocol Data Unit (PDU) or a PDCP service data unit (SDU). Of course, the first data packet may also be a Service Data Adaptation Protocol (SDAP) PDU, which is not specifically limited in the present application.

Exemplarily, when the first data packet is the to-be-compressed data packet, the first data packet may include at least one of the following:
a PDCP header, an SDAP header, an Ethernet frame header, an IP header, or a payload (or a remaining portion).

Exemplarily, when the first data packet is the compressed data packet, the first data packet may include at least one of the following:
a PDCP header, an SDAP header, an EHC header, an ROHC header, a UDC header or a data block.

Exemplarily, the data block may be data formed by compression for the payload or the remaining portion.

It should be understood that, the description involved in the present application “performing a compression or decompression operation on a first data packet based on at least one compression protocol” may also be equivalently replaced by a description with a same or similar meaning, which is not specifically limited in the present application. Exemplarily, the “performing a compression or decompression operation on a first data packet based on at least one compression protocol” may be equivalently replaced by any of the following:
performing the compression or decompression operation on the first data packet based on at least one compression configuration;
performing the compression or decompression operation on the first data packet based on a parameter indicated by at least one compression configuration;
performing the compression or decompression operation on the first data packet based on at least one compression function;
performing the compression or decompression operation on the first data packet based on at least one compression module;
performing the compression or decompression operation on the first data packet based on at least one compression function respectively enabling at least one compression configuration;
performing the compression or decompression operation on the first data packet based on at least one compression module respectively enabling at least one compression configuration;
performing the compression or decompression operation on the first data packet by at least one compression function using at least one compression configuration respectively;
performing the compression or decompression operation on the first data packet by at least one compression module using at least one compression configuration respectively.

Similarly, the term “UDC protocol” involved in the present application may be replaced by “UDC function”, “UDC module”, “UDC configuration”, “UDC function enabled by UDC configuration”, “UDC module enabled by UDC configuration”, “UDC configuration used by UDC function”, “UDC module used by UDC configuration” and other descriptions with a same or similar meaning. In addition, the term “ROHC protocol” involved in the present application may be replaced by “ROHC function”, “ROHC module”, “ROHC configuration”, “ROHC function enabled by ROHC configuration”, “ROHC module enabled by ROHC configuration”, “ROHC configuration used by ROHC function”, “ROHC module used by ROHC configuration” and other descriptions with a same or similar meaning. In addition, the term “EHC protocol” involved in the present application may be replaced by “EHC function”, “EHC module”, “EHC configuration”, “EHC function enabled by the EHC configuration”, “EHC module enabled by the EHC configuration”, “EHC configuration used by the EHC function”, “EHC module used by the EHC configuration” and other descriptions with a same or similar meaning, the present application does not specifically limit thereto.

In some embodiments, when a compression buffer and a decompression buffer are synchronized, the communication device performs the compression or decompression operation based on the UDC protocol. When asynchronism or an error is detected, a buffer reset mechanism may be used to reset the buffer. For resynchronization, the terminal device needs to reset the compression buffer to all zeros. Exemplarily, the asynchronism or error of the compression buffer and the decompression buffer may be indicated by a UDC checksum error notification PDCP control PDU, and when the terminal device receives the notification, a buffer reset process of the terminal device is triggered, thereby resetting the buffer. Resetting the buffer may refer to resetting the compression buffer.

In some embodiments, the at least one compression protocol further includes at least one of the following protocols: an Ethernet frame header compression (EHC) protocol, or a robust header compression (ROHC) protocol.

In some embodiments, the service data adaptation protocol (SDAP) header in the first data packet is not compressed; and/or, when the first data packet is an SDAP control protocol data unit (PDU), the SDAP control PDU is not compressed.

In some embodiments, the service data adaptation protocol (SDAP) header in the first data packet is compressed; and/or, when the first data packet is the SDAP control protocol data unit (PDU), the SDAP control PDU is compressed.

In some embodiments, the S210 may include:
based on the UDC protocol, performing the compression or decompression operation on the SDAP header in the first data packet.

In some embodiments, the S210 may include:
when the first data packet is the SDAP control PDU, performing the compression or decompression operation on the first data packet as a whole based on the UDC protocol.

In some embodiments, the first data packet or a compressed packet of the first data packet includes at least one of the following in sequence: a PDCP header, a UDC header, or a data block.

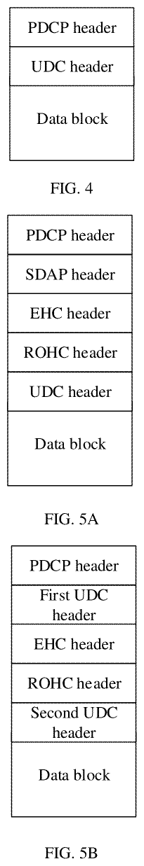

FIG. 4 is a schematic diagram of a compressed packet formed by compressing an SDAP control PDU, provided by the embodiments of the present application. As shown in FIG. 4, the first data packet or the compressed packet of the first data packet includes the PDCP header, the UDC header and the data block in sequence.

In some embodiments, the S210 may include:
when at least one of the following is met, performing the compression or decompression operation on the first data packet as a whole based on the UDC protocol: the compression or decompression operation being performed on the SDAP header; the compression or decompression operation being performed on the SDAP control PDU; UDC configuration being configured;
the UDC configuration and ROHC configuration being configured;
the UDC configuration and EHC configuration being configured;
the UDC configuration, the EHC configuration and the ROHC configuration being configured;
the UDC configuration and the ROHC configuration being configured not simultaneously;
the UDC configuration and the EHC configuration being configured not simultaneously; first indication information being indicated or configured, where the first indication information is used to indicate whether to perform the compression or decompression operation on the SDAP header and/or the SDAP control PDU;
second indication information being indicated or configured, where the second indication information is used to indicate a filed or information of performing a UDC compression or decompression operation;
a predefined rule indicating that the compression or decompression operation is not performed on the SDAP header and/or the SDAP control PDU; or
a predefined rule indicating that the compression or decompression operation is performed on the SDAP header and/or the SDAP control PDU.

In some embodiments, the UDC protocol is used to compress at least one of: an SDAP header, an Ethernet frame header, an IP header, a payload, a remaining portion of the first data packet except a packet header, or an uncompressed remaining portion of the first data packet.

It needs to be noted that, in the embodiments of the present application, the “predefined” may be implemented by pre-saving corresponding codes, tables or other manners that may be used for indicating related information, in the device (for example, including the terminal device and the network device), and the present application does not limit its implementations. For example, a predefined rule may refer to a rule defined in a protocol. Optionally, the “protocol” may refer to a standard protocol in the field of communication, which may include, for example, the LTE protocol, the NR protocol, and the related protocols applied in the future communication system, and the present application is not specifically limited thereto.

In some embodiments, the EHC protocol in the at least one compression protocol is used to compress an Ethernet frame header; and/or, the ROHC protocol in the at least one compression protocol is used to compress an Internet protocol (IP) header; and/or, the UDC protocol is used to compress a payload and/or an uncompressed remaining portion of the first data packet.

Exemplarily, the uncompressed remaining portion of the first data packet includes: an uncompressed remaining portion of the first data packet except a packet header.

Exemplarily, the packet header includes at least one of: a PDCP header, an SDAP header, an Ethernet frame header, or an IP header.

Exemplarily, the first data packet or a compressed packet of the first data includes at least one of: a PDCP header, an SDAP header, an EHC header, an ROHC header, a UDC header, or a data block.

In some embodiments, the S210 may include:
performing the compression or decompression operation on the first data packet based on at least one of the EHC protocol, the ROHC protocol or the UDC protocol.

In some embodiments, the S210 may include:
when at least one of the following is met, performing the compression or decompression operation on the first data packet based on at least one of the EHC protocol, the ROHC protocol, or the UDC protocol:
UDC configuration, EHC configuration and ROHC configuration being configured;
the UDC configuration and the ROHC configuration being configured simultaneously;
the UDC configuration and the EHC configuration being configured simultaneously; or
the first data packet including at least one of the Ethernet frame header, the IP header, or the payload.

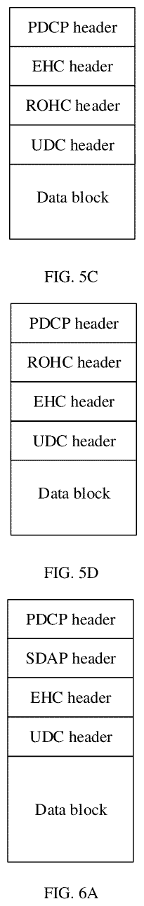

FIGS. 5A to 5D are schematic diagrams of a compressed packet formed by performing a compression operation on a first data packet based on at least one of an EHC protocol, an ROHC protocol, or a UDC protocol, provided by the embodiments of the present application. A format of the first data packet or the compressed packet of the first data packet is exemplarily illustrated below with reference to FIGS. 5A to 5D.

In some embodiments, the S210 may include:
when the compression or decompression operation is not performed on a service data adaptation protocol (SDAP) header in the first data packet, performing the compression or decompression operation on the first data packet based on the EHC protocol, the ROHC protocol and the UDC protocol in sequence;
where the first data packet or a compressed packet of the first data packet includes at least one of the following in sequence: a PDCP header, an SDAP header, an EHC header, an ROHC header, a UDC header or a data block.

Exemplarily, as shown in FIG. 5A, the first data packet or the compressed packet of the first data packet includes in sequence: the PDCP header, the SDAP header, the EHC header, the ROHC header, the UDC header and the data block.

In some embodiments, the S210 may include:
when the compression or decompression operation is performed on a service data adaptation protocol (SDAP) header in the first data packet, after performing the compression or decompression operation on the SDAP header based on the UDC protocol, performing the compression or decompression operation on the first data packet based on the EHC protocol, the ROHC protocol and the UDC protocol in sequence;
where the first data packet or a compressed packet of the first data packet includes at least one of the following in sequence: a PDCP header, a first UDC header, an EHC header, an ROHC header, a second UDC header, or a data block.

Exemplarily, the first UDC header includes a data block.

Exemplarily, the first UDC header includes a UDC header and a data block obtained by performing the compression operation on the SDAP header.

Exemplarily, the second UDC header includes a packet header obtained by compressing the payload of the first data packet and/or the uncompressed remaining portion of the first data packet. Optionally, the uncompressed remaining portion of the first data packet includes: an uncompressed remaining portion of the first data packet except the packet header. Optionally, the packet header includes at least one of: a PDCP header, an SDAP header, an Ethernet frame header, or an IP header.

Exemplarily, as shown in FIG. 5B, the first data packet or the compressed packet of the first data packet includes in sequence: the PDCP header, the first UDC header, the EHC header, the ROHC header, the second UDC header, and the data block.

In some embodiments, the S210 may include:
when the compression or decompression operation is performed on a service data adaptation protocol (SDAP) header in the first data packet, performing the compression or decompression operation on the first data packet based on the EHC protocol, the ROHC protocol and the UDC protocol in sequence;
where the first data packet or a compressed packet of the first data packet includes at least one of the following in sequence: a PDCP header, an EHC header, an ROHC header, a UDC header or a data block.

Exemplarily, as shown in FIG. 5C, the first data packet or the compressed packet of the first data packet includes in sequence: the PDCP header, the EHC header, the ROHC header, the UDC header, and the data block.

In some embodiments, the S210 may include:
when the compression or decompression operation is performed on a service data adaptation protocol (SDAP) header in the first data packet, performing the compression or decompression operation on the first data packet based on the ROHC protocol, the EHC protocol and the UDC protocol in sequence;
where the first data packet or a compressed packet of the first data packet includes at least one of the following in sequence: a PDCP header, an ROHC header, an EHC header, a UDC header or a data block.

Exemplarily, as shown in FIG. 5D, the first data packet or the compressed packet of the first data packet includes in sequence: the PDCP header, the ROHC header, the EHC header, the UDC header, and the data block.

In some embodiments, the EHC protocol in the at least one compression protocol is used to compress an Ethernet frame header; and/or, the UDC protocol is used to compress at least one of: a payload, an Internet protocol (IP) header, or a remaining portion of the first data packet except a packet header.

Exemplarily, the first data packet or the compressed packet of the first data includes at least one of: a PDCP header, an SDAP header, an EHC header, a UDC header or a data block.

In some embodiments, the S210 may include:
performing the compression or decompression operation on the first data packet based on at least one of the EHC protocol or the UDC protocol.

In some embodiments, the S210 may include:
when at least one of the following is met, performing the compression or decompression operation on the first data packet based on at least one of the EHC protocol or the UDC protocol:
the first data packet being a non-IP Ethernet frame packet;
the compression or decompression operation being performed on an IP header in the first data packet based on the UDC protocol; UDC configuration and EHC configuration being configured;
the UDC configuration, the EHC configuration and ROHC configuration being configured;
the UDC configuration and the ROHC configuration being configured not simultaneously; or
the first data packet including at least one of the Ethernet frame header, the IP header, or the payload.

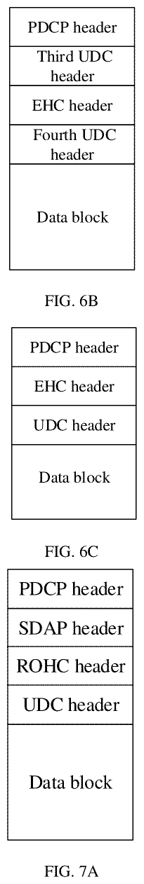

FIGS. 6A to 6C are schematic diagrams of a compressed packet formed by performing a compression operation on a first data packet based on at least one of an EHC protocol or a UDC protocol, provided by the embodiments of the present application. A format of the first data packet or the compressed packet of the first data packet is exemplarily illustrated below with reference to FIGS. 6A to 6C.

In some embodiments, the S210 may include:
when the compression or decompression operation is not performed on a service data adaptation protocol (SDAP) header in the first data packet, performing the compression or decompression operation on the first data packet based on the EHC protocol and the UDC protocol in sequence;
where the first data packet or a compressed packet of the first data packet includes at least one of the following in sequence: a PDCP header, an SDAP header, an EHC header, a UDC header or a data block.

Exemplarily, as shown in FIG. 6A, the first data packet or the compressed packet of the first data packet includes in sequence: the PDCP header, the SDAP header, the EHC header, the UDC header, and the data block.

In some embodiments, the S210 may include:
when the compression or decompression operation is performed on a service data adaptation protocol (SDAP) header in the first data packet, after performing the compression or decompression operation on the SDAP header based on the UDC protocol, performing the compression or decompression operation on the first data packet based on the EHC protocol and the UDC protocol in sequence;
where the first data packet or a compressed packet of the first data packet includes at least one of the following in sequence: a PDCP header, a third UDC header, an EHC header, a fourth UDC header, or a data block.

Exemplarily, the third UDC header includes a data block.

Exemplarily, the third UDC header includes a UDC header and a data block obtained by performing the compression operation on the SDAP header.

Exemplarily, the fourth UDC header includes a packet header obtained by compressing the payload in the first data packet and/or the uncompressed remaining portion of the first data packet. Optionally, the uncompressed remaining portion of the first data packet includes: an uncompressed remaining portion of the first data packet except the packet header. Optionally, the packet header includes at least one of: the PDCP header, the SDAP header, the Ethernet frame header, or the IP header.

Exemplarily, as shown in FIG. 6B, the first data packet or the compressed packet of the first data packet includes in sequence: the PDCP header, the third UDC header, the EHC header, the fourth UDC header, and the data block.

In some embodiments, the S210 may include:
when the compression or decompression operation is performed on a service data adaptation protocol (SDAP) header in the first data packet, performing the compression or decompression operation on the first data packet based on the EHC protocol and the UDC protocol in sequence;
where the first data packet or the compressed packet of the first data packet includes at least one of the following in sequence: a PDCP header, an EHC header, a UDC header, or a data block.

Exemplarily, as shown in FIG. 6C, the first data packet or the compressed packet of the first data packet includes in sequence: the PDCP header, the EHC header, the UDC header, and the data block.

In some embodiments, the ROHC protocol in the at least one compression protocol is used to compress an Internet protocol (IP) header; and/or, the UDC protocol is used to compress at least one of: a payload, the Ethernet frame header, or a remaining portion of the first data packet except a packet header.

Exemplarily, the first data packet or the compressed packet of the first data includes at least one of: a PDCP header, an SDAP header, an ROHC header, a UDC header, or a data block.

In some embodiments, the S210 may include:
performing the compression or decompression operation on the first data packet based on at least one of the ROHC protocol or the UDC protocol.

In some embodiments, the S210 may include:
when at least one of the following is met, performing the compression or decompression operation on the first data packet based on at least one of the ROHC protocol or the UDC protocol:
the first data packet being an IP packet;
the first data packet being a non-Ethernet frame packet;
the compression or decompression operation being performed on an IP header in the first data packet based on the UDC protocol;
UDC configuration and ROHC configuration being configured;
the UDC configuration, the ROHC configuration and EHC configuration being configured;
the UDC configuration and the EHC configuration being configured not simultaneously;
or
the first data packet including at least one of the Ethernet frame header, the IP header, or the payload.

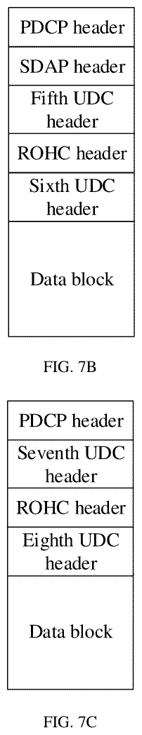

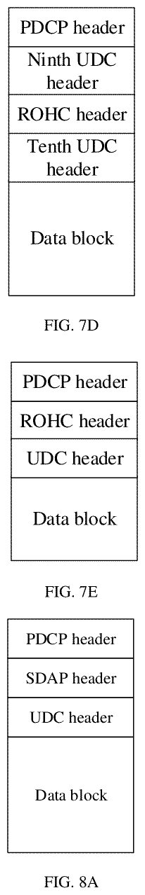

FIGS. 7A to 7E are schematic diagrams of a compressed packet formed by performing a compression operation on a first data packet based on at least one of an ROHC protocol or a UDC protocol, provided by the embodiments of the present application. A format of the first data packet or the compressed packet of the first data packet is exemplarily illustrated below with reference to FIGS. 7A to 7E.

In some embodiments, the S210 may include:
when the compression or decompression operation is not performed on a service data adaptation protocol (SDAP) header in the first data packet, performing the compression or decompression operation on the first data packet based on the ROHC protocol and the UDC protocol in sequence;
where the first data packet or a compressed packet of the first data packet includes at least one of the following in sequence: a PDCP header, an SDAP header, an ROHC header, a UDC header or a data block.

Exemplarily, as shown in FIG. 7A, the first data packet or the compressed packet of the first data packet includes in sequence: the PDCP header, the SDAP header, the ROHC header, the UDC header, and the data block.

In some embodiments, the S210 may include:
when the first data packet is an Ethernet frame packet, and the compression or decompression operation is not performed on a service data adaptation protocol (SDAP) header in the first data packet, after performing the compression or decompression operation on the Ethernet frame header in the first data packet based on the UDC protocol, performing the compression or decompression operation on the first data packet based on the ROHC protocol and the UDC protocol in sequence;
where the first data packet or a compressed packet of the first data packet includes at least one of the following in sequence: a PDCP header, an SDAP header, a fifth UDC header, an ROHC header, a sixth UDC header, or a data block.

Exemplarily, the fifth UDC header includes a data block.

Exemplarily, the fifth UDC header includes a UDC header and a data block obtained by performing the compression operation on the Ethernet frame header.

Exemplarily, the sixth UDC header includes a packet header obtained by compressing the payload in the first data packet and/or the uncompressed remaining portion of the first data packet. Optionally, the uncompressed remaining portion of the first data packet includes: an uncompressed remaining portion of the first data packet except the packet header. Optionally, the packet header includes at least one of: the PDCP header, the SDAP header, the Ethernet frame header, or the IP header.

Exemplarily, as shown in FIG. 7A, the first data packet or the compressed packet of the first data packet includes in sequence: the PDCP header, the SDAP header, the ROHC header, the UDC header, and the data block.

In some embodiments, the S210 may include:
when the first data packet is an Ethernet frame packet, and the compression or decompression operation is not performed on a service data adaptation protocol (SDAP) header in the first data packet, performing the compression or decompression operation on the first data packet based on the ROHC protocol and the UDC protocol in sequence;
where the first data packet or a compressed packet of the first data packet includes at least one of the following in sequence: a PDCP header, an SDAP header, an ROHC header, a UDC header or a data block.

Exemplarily, the UDC header includes a UDC header and a data block obtained by performing the compression operation on the Ethernet frame header.

Exemplarily, the UDC header includes a packet header obtained by compressing the payload in the first data packet and/or the uncompressed remaining portion of the first data packet. Optionally, the uncompressed remaining portion of the first data packet includes: an uncompressed remaining portion of the first data packet except the packet header. Optionally, the packet header includes at least one of: the PDCP header, the SDAP header, the Ethernet frame header, or the IP header.

Exemplarily, as shown in FIG. 7A, the first data packet or the compressed packet of the first data packet includes in sequence: the PDCP header, the SDAP header, the ROHC header, the UDC header, and the data block.

In some embodiments, the S210 may include:
when the compression or decompression operation is performed on a service data adaptation protocol (SDAP) header in the first data packet, after performing the compression or decompression operation on the SDAP header based on the UDC protocol, performing the compression or decompression operation on the first data packet based on the ROHC protocol and the UDC protocol in sequence;
where the first data packet or a compressed packet of the first data packet includes at least one of the following in sequence: a PDCP header, a seventh UDC header, an ROHC header, an eighth UDC header, or a data block.

Exemplarily, the seventh UDC header includes a data block.

Exemplarily, the seventh UDC header includes a UDC header and a data block obtained by performing a compression operation on the SDAP header.

Exemplarily, the eighth UDC header includes a packet header obtained by compressing the payload in the first data packet and/or the uncompressed remaining portion of the first data packet. Optionally, the uncompressed remaining portion of the first data packet includes: an uncompressed remaining portion of the first data packet except the packet header. Optionally, the packet header includes at least one of: the PDCP header, the SDAP header, the Ethernet frame header, or the IP header.

Exemplarily, as shown in FIG. 7C, the first data packet or the compressed packet of the first data packet includes in sequence: the PDCP header, the seventh UDC header, the ROHC header, the eighth UDC header, and the data block.

In some embodiments, the S210 may include:
when the first data packet is an Ethernet frame packet, and the compression or decompression operation is performed on a service data adaptation protocol (SDAP) header in the first data packet, after performing the compression or decompression operation on the SDAP header and the Ethernet frame header in the first data packet based on the UDC protocol, performing the compression or decompression operation on the first data packet based on the ROHC protocol and the UDC protocol in sequence;
where the first data packet or a compressed packet of the first data packet includes at least one of the following in sequence: a PDCP header, a ninth UDC header, an ROHC header, a tenth UDC header, or a data block.

Exemplarily, the ninth UDC header includes a data block.

Exemplarily, the ninth UDC header includes a UDC header and a data block obtained by performing the compression operation on the SDAP header and the Ethernet frame header of the first data packet.

Exemplarily, the tenth UDC header includes a packet header obtained by compressing the payload in the first data packet and/or the uncompressed remaining portion of the first data packet. Optionally, the uncompressed remaining portion of the first data packet includes: an uncompressed remaining portion of the first data packet except the packet header. Optionally, the packet header includes at least one of: the PDCP header, the SDAP header, the Ethernet frame header, or the IP header.

Exemplarily, as shown in FIG. 7D, the first data packet or the compressed packet of the first data packet includes in sequence: the PDCP header, the ninth UDC header, the ROHC header, the tenth UDC header, and the data block.

In some embodiments, the S210 may include:
when the first data packet is an Ethernet frame packet, and the compression or decompression operation is performed on a service data adaptation protocol (SDAP) header in the first data packet, performing the compression or decompression operation on the first data packet based on the ROHC protocol and the UDC protocol in sequence;
where the first data packet or a compressed packet of the first data packet includes at least one of the following in sequence: a PDCP header, an ROHC header, a UDC header or a data block.

Exemplarily, as shown in FIG. 7E, the first data packet or the compressed packet of the first data packet includes in sequence: the PDCP header, the ROHC header, the UDC header, and the data block.

In some embodiments, the UDC protocol is used to compress at least one of: the IP header, the payload, the Ethernet frame header, or the remaining portion of the first data packet except the packet header.

Exemplarily, the first data packet or the compressed packet of the first data packet includes at least one of: the PDCP header, the SDAP header, the UDC header, or the data block.

In some embodiments, the packet header includes at least one of: the PDCP header, the SDAP header, the Ethernet frame header, or the IP header.

In some embodiments, the S210 may include:
performing the compression or decompression operation on the first data packet based on the UDC protocol.

In some embodiments, the S210 may include:
when at least one of the following is met, performing the compression or decompression operation on the first data packet based on the UDC protocol: the compression or decompression operation being performed on the Ethernet frame header, the IP header and a data portion in the first data packet based on the UDC protocol;
the compression or decompression operation being performed on the data portion in the first data packet based on the UDC protocol;
the first data packet being an IP packet;
the first data packet being an Ethernet frame packet;
UDC configuration being configured;
the UDC configuration and ROHC configuration being configured;
the UDC configuration and EHC configuration being configured;
the UDC configuration, the EHC configuration and the ROHC configuration being configured;
the UDC configuration and the ROHC configuration being configured not simultaneously;
the UDC configuration and the EHC configuration being configured not simultaneously;
or
the first data packet including at least one of the Ethernet frame header, the IP header, or the payload.

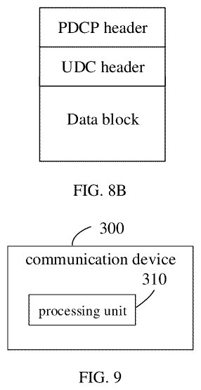

FIGS. 8A to 8B are schematic diagrams of a compressed packet formed by performing a compression operation on a first data packet based on a UDC protocol, provided by the embodiments of the present application. A format of the first data packet or the compressed packet of the first data packet is exemplarily illustrated below with reference to FIGS. 8A to 8B.

In some embodiments, the S210 may include:
when the compression or decompression operation is not performed on a service data adaptation protocol (SDAP) header in the first data packet, performing the compression or decompression operation on the first data packet based on the UDC protocol;
where the first data packet or a compressed packet of the first data packet includes at least one of the following in sequence: a PDCP header, an SDAP header, a UDC header, or a data block.

Exemplarily, as shown in FIG. 8A, the first data packet or the compressed packet of the first data packet includes in sequence: the PDCP header, the SDAP header, the UDC header, and the data block.

In some embodiments, the S210 may include:
when the compression or decompression operation is performed on a service data adaptation protocol (SDAP) header in the first data packet, performing the compression or decompression operation on the first data packet based on the UDC protocol;
where the first data packet or a compressed packet of the first data packet includes at least one of the following in sequence: a PDCP header, a UDC header or a data block.

Exemplarily, as shown in FIG. 8B, the first data packet or the compressed packet of the first data packet includes in sequence: the PDCP header, the UDC header, and the data block.

In some embodiments, the first data packet or the compressed packet of the first data packet includes third indication information, and the third indication information is used to indicate at least one of:
whether an SDAP header is compressed;
a number of bits occupied by the SDAP header or a number of bits occupied by a compressed SDAP header; or
a starting position or an ending position occupied by the compressed SDAP header.

Exemplarily, the third indication information is carried in a PDCP PDU or a UDC PDU or a UDC header.

In some embodiments, the first data packet or the compressed packet of the first data packet includes fourth indication information, and the fourth indication information is used to indicate at least one of:
whether an Ethernet frame header is compressed;
a number of bits occupied by the Ethernet frame header or a number of bits occupied by a compressed Ethernet frame header; or
a starting position or an ending position occupied by the compressed Ethernet frame header.

Exemplarily, the fourth indication information is carried in a PDCP PDU or a UDC PDU or a UDC header.

In some embodiments, the first data packet or the compressed packet of the first data packet includes fifth indication information, and the fifth indication information is used to at least one of:
whether an IP header is compressed;
a number of bits occupied by the IP header or a number of bits occupied by a compressed IP header; or
a starting position or an ending position occupied by the compressed IP header.

Exemplarily, the fifth indication information is carried in a PDCP PDU or a UDC PDU or a UDC header.

In some embodiments, the first data packet or the compressed packet of the first data packet includes sixth indication information, and the sixth indication information is used to indicate whether to bypass an IP protocol and/or an ROHC protocol.

Exemplarily, the sixth indication information being used to indicate whether to bypass the IP protocol and/or the ROHC protocol, may be equivalently replaced with: the sixth indication information being used to indicate whether to not perform the IP protocol and/or the ROHC protocol.

Exemplarily, the sixth indication information is carried in a PDCP PDU or a UDC PDU or a UDC header.

In some embodiments, the first data packet or the compressed packet of the first data packet includes seventh indication information, and the seventh indication information is used to indicate whether to bypass an Ethernet frame protocol and/or an EHC protocol.

Exemplarily, the seventh indication information is carried in a PDCP PDU or a UDC PDU or a UDC header.

In some embodiments, when the compression or decompression operation is performed on the service data adaptation protocol (SDAP) header in the first data packet, and the compression or decompression operation is performed on the first data packet based on the EHC protocol, the ROHC protocol and the UDC protocol in sequence, the first data packet or the compressed packet of the first data packet includes at least one of the third indication information, the fourth indication information, the fifth indication information, the sixth indication information or the seventh indication information.

In some embodiments, when the first data packet or the compressed packet of the first data packet includes at least one of the PDCP header, the EHC header, the ROHC header, the UDC header, or the data block in sequence, the first data packet or the compressed packet of the first data packet includes at least one of the third indication information, the fourth indication information, the fifth indication information, the sixth indication information, or the seventh indication information.

Exemplarily, as shown in FIG. 5C, when the first data packet or the compressed packet of the first data packet includes the PDCP header, the EHC header, the ROHC header, the UDC header and the data block in sequence, the first data packet or the compressed packet of the first data packet includes at least one of the third indication information, the fourth indication information, the fifth indication information, the sixth indication information, or the seventh indication information.

In some embodiments, when the compression or decompression operation is performed on the service data adaptation protocol (SDAP) header in the first data packet, and the compression or decompression operation is performed on the first data packet based on the ROHC protocol, the EHC protocol and the UDC protocol in sequence, the first data packet or the compressed packet of the first data packet includes at least one of the third indication information, the fourth indication information, the fifth indication information, the sixth indication information or the seventh indication information.

In some embodiments, when the first data packet or the compressed packet of the first data packet includes at least one of the PDCP header, the ROHC header, the EHC header, the UDC header, or the data block in sequence, the first data packet or the compressed packet of the first data packet includes at least one of the third indication information, the fourth indication information, the fifth indication information, the sixth indication information, or the seventh indication information.

Exemplarily, as shown in FIG. 5D, when the first data packet or the compressed packet of the first data packet includes the PDCP header, the ROHC header, the EHC header, the UDC header and the data block in sequence, the first data packet or the compressed packet of the first data packet includes at least one of the third indication information, the fourth indication information, the fifth indication information, the sixth indication information, or the seventh indication information.

In some embodiments, when the compression or decompression operation is performed on the service data adaptation protocol (SDAP) header in the first data packet, when the compression or decompression operation is performed on the first data packet based on the EHC protocol and the UDC protocol in sequence, the first data packet or the compressed packet of the first data packet includes at least one of the third indication information, the fourth indication information, the fifth indication information, and the sixth indication information, or the seventh indication information.

In some embodiments, when the first data packet or the compressed packet of the first data packet includes at least one of the PDCP header, the EHC header, the UDC header or the data block in sequence, the first data packet or the compressed packet of the first data packet includes at least one of the third indication information, the fourth indication information, the fifth indication information, the sixth indication information, or the seventh indication information.

Exemplarily, when the first data packet is not an IP packet or does not include an IP header, when the first data packet or the compressed packet of the first data packet includes at least one of the PDCP header, the EHC header, the UDC header or the data block in sequence, the first data packet or the compressed packet of the first data packet includes at least one of the third indication information, the fourth indication information, the fifth indication information, the sixth indication information or the seventh indication information.

Exemplarily, as shown in FIG. 6C, when the first data packet or the compressed packet of the first data packet includes the PDCP header, the EHC header, the UDC header and the data block in sequence, the first data packet or the compressed packet of the first data packet includes at least one of the third indication information, the fourth indication information, the fifth indication information, the sixth indication information, or the seventh indication information.

In some embodiments, when the first data packet or the compressed packet of the first data packet includes at least one of the PDCP header, the ROHC header, the UDC header, or the data block in sequence, the first data packet or the compressed packet of the first data packet includes at least one of the third indication information, the fourth indication information, the fifth indication information, the sixth indication information, or the seventh indication information.

In some embodiments, when the first data packet is an Ethernet frame packet or includes an Ethernet frame header, when the first data packet or the compressed packet of the first data packet includes at least one of the PDCP header, the ROHC header, and the UDC header or the data block in sequence, the first data packet or the compressed packet of the first data packet includes at least one of the third indication information, the fourth indication information, the fifth indication information, the sixth indication information or the seventh indication information.

Exemplarily, when the first data packet is not the Ethernet frame packet or does not include the Ethernet frame header, the first data packet or the compressed packet of the first data packet includes at least one of the PDCP header, the ROHC header, the UDC header, or the data block in sequence, the first data packet or the compressed packet of the first data packet includes at least one of the third indication information, the fourth indication information, the fifth indication information, the sixth indication information, or the seventh indication information.

Exemplarily, as shown in FIG. 7E, when the first data packet or the compressed packet of the first data packet includes the PDCP header, the ROHC header, the UDC header and the data block in sequence, the first data packet or the compressed packet of the first data packet includes at least one of the third indication information, the fourth indication information, the fifth indication information, the sixth indication information, or the seventh indication information.

In some embodiments, the method 200 may also include:
receiving or transmitting UDC configuration, where the UDC configuration meets at least one of:
both a network device and a terminal device being entities that support a new radio (NR) version;
the network device being a base station in an NR system;
the UDC configuration being configured for a data radio bearer (DRB) and/or the terminal device;
the UDC configuration being carried in packet data convergence protocol (PDCP) configuration;
the UDC configuration being carried in bearer configuration;
the UDC configuration including at least one of a buffer size or a dictionary;
the UDC configuration being configured with at least one of the following configuration simultaneously: EHC configuration, or ROHC configuration;
the UDC configuration being configured with at least one of the following configuration not simultaneously: EHC configuration, or ROHC configuration;
the UDC configuration being configured with at least one of the following configuration not simultaneously: dual active protocol stack (DAPS) configuration, control handover (CHO) configuration, out-of-order transmission configuration, repetition configuration, or furcation transmission configuration;
the UDC configuration being configured with at least one of the following configuration simultaneously: DAPS configuration, repetition configuration, or furcation transmission configuration;
radio resource control (RRC) configuration, PDCP configuration, DAPS configuration or the UDC configuration including eighth indication information, and the eighth indication information being used to indicate whether a dual active protocol stack handover (DAPS HO) supports the UDC configuration;
the RRC configuration, the PDCP configuration, the DAPS configuration or the UDC configuration including ninth indication information, and the ninth indication information being used to indicate whether to continue to use the UDC configuration, or to indicate whether to continue to use the UDC configuration when PDCP reestablishment is performed;
a radio link control (RLC) mode corresponding to the UDC configuration being an acknowledged mode (AM);
a RLC mode corresponding to the UDC configuration being a bi-directional unacknowledged mode (UM); or
the UDC configuration or a filed corresponding to the UDC configuration being configured for a bi-directional data radio bearer (DRB).

Exemplarily, the ninth indication information may also be referred to as UDC continuity configuration, for short.

Exemplarily, the ninth indication information may be DRB-ContinueUDC signaling or DRB-ContinueUDC-UL signaling.

Exemplarily, the RLC mode corresponding to the UDC configuration may be configured by RLC configuration (RLC-Config) or RLC bearer configuration (RLC-BearerConfig). For example, the radio link control (RLC) mode corresponding to the UDC configuration is the acknowledged mode (AM), which may be configured by the RLC configuration (RLC-Config) or the RLC bearer configuration (RLC-BearerConfig). For another example, the RLC mode corresponding to the UDC configuration is a bi-directional unacknowledged mode (UM), which may be configured by the RLC configuration (RLC-Config) or the RLC bearer configuration (RLC-BearerConfig).

In some embodiments, the UDC configuration is configured when PDCP reestablishment configuration is configured, and/or, the UDC configuration is configured when the ninth indication information is not configured.

In some embodiments, the radio link control (RLC) mode corresponding to the UDC configuration being the acknowledged mode (AM), includes: the RLC mode corresponding to at least one of the following corresponding to the UDC configuration being the acknowledged mode (AM): a bearer, a logical channel, or RLC.

In some embodiments, the RLC mode corresponding to the UDC configuration being the bi-directional unacknowledged mode (UM), includes: the RLC mode corresponding to at least one of the following corresponding to the UDC configuration being the bi-directional unacknowledged mode (UM): a bearer, a logical channel, or RLC.

In some embodiments, when configuration information of DAPS is configured for the terminal device, the RRC configuration, the PDCP configuration, the DAPS configuration or the UDC configuration includes the eighth indication information.

In some embodiments, the ninth indication information is configured in a case of a radio resource control (RRC) connection being resumed or handover.

In some embodiments, a configured PDCP entity remains unchanged and does not indicate full configuration.

In some embodiments, when a configured bearer is a DAPS bearer, the ninth indication information is not configured.

In some embodiments, the eighth indication information is used to indicate that the DAPS HO supports the UDC configuration.

In some embodiments, at least one of a UDC buffer, a UDC synchronization state, or UDC context information corresponding to the UDC configuration is transmitted by a source network device to a target network device or is transmitted by the terminal device to the target network device.

In some embodiments, the at least one of the UDC buffer, the UDC synchronization state, or the UDC context information corresponding to the UDC configuration being transmitted by the source network device to the target network device or being transmitted by the terminal device to the target network device, includes: when the ninth indication information is used to indicate to continue to use the UDC configuration when the PDCP reestablishment is performed, the at least one of the UDC buffer, the UDC synchronization state, or the UDC context information corresponding to the UDC configuration being transmitted by the source network device to the target network device or is transmitted by the terminal device to the target network device.

In some embodiments, the UDC configuration between the terminal device and a source network device is used before uplink handover in a case of performing the DAPS HO; and/or, the UDC configuration configured by the source network device is used before uplink handover in a case of performing the DAPS HO.

In some embodiments, the UDC configuration between the terminal device and a target network device is used after uplink handover; and/or, the UDC configuration configured by a source network device is used after uplink handover; and/or, the UDC configuration configured by the target network device is used after uplink handover.

Exemplarily, in a case where the ninth indication information is configured, the UDC configuration configured by the source network device is used after uplink handover; in a case where the ninth indication information is not configured and the eighth indication information is configured, the UDC configuration configured by the target network device is used after uplink handover.

In some embodiments, the eighth indication information is used to indicate not to continue to use the UDC configuration; and/or, the eighth indication information is used to indicate not to continue to use the UDC configuration when the PDCP reestablishment is performed; and/or, the eighth indication information is not carried in the RRC configuration, the PDCP configuration, the DAPS configuration or the UDC configuration.

In some embodiments, the method 200 may also include:
performing at least one of:
resetting a compression buffer to all zeros or a pre-defined dictionary;
decompressing all stored PDCP service data units (SDUs) by using the UDC configuration; or
after decompressing all the stored PDCP SDUs by using the UDC configuration, resetting the compression buffer to all zeros or the pre-defined dictionary.

In some embodiments, the method 200 may also include:
in a case where a first condition is met, performing at least one of:
resetting the compression buffer to all zeros or the pre-defined dictionary;
decompressing all the stored PDCP service data units (SDUs) by using the UDC configuration; or
after decompressing all the stored PDCP SDUs by using the UDC configuration, resetting the compression buffer to all zeros or the pre-defined dictionary;
where the first condition includes at least one of:
being in a process of performing the DAPS HO;
being in a process of performing the DAPS HO and the eighth indication information
being used to indicate that the DAPS HO does not support the UDC configuration;
being in a process of performing the DAPS HO and the ninth indication information being used to indicate not to continue to use the UDC configuration or to indicate not to continue to use the UDC configuration when the PDCP reestablishment is performed; or
being in a process of performing uplink handover.

Exemplarily, the pre-defined dictionary may include standard and operator defined dictionaries.

In some embodiments, the eighth indication information is used to indicate to continue to use the UDC configuration when the PDCP reestablishment is performed; and/or, the eighth indication information is carried in the RRC configuration, the PDCP configuration, the DAPS configuration or the UDC configuration.

In some embodiments, the method 200 may also include:
continuing to use a buffer of the UDC configuration without resetting the buffer.

Exemplarily a compression buffer and a decompression buffer of the UDC configuration are continued to be used, and the compression buffer and the decompression buffer are not reset.

In some embodiments, the method 200 may also include:
receiving or transmitting at least one of the following configuration: ROHC configuration, or EHC configuration.

The schemes of the present application are illustrated below in combination with some embodiments.

### Embodiment 1

in this embodiment, the network device transmits the UDC configuration to the UE. Correspondingly, the UE receives the UDC configuration transmitted by the network device, and performs a UDC function or a related operation based on the UDC configuration.

Exemplarily, the UDC configuration may include at least one of the following.
a). The network device and the UE are entities that support the NR version.
b). The network device is a gNB.
c). The UDC configuration is per DRB (per UE, per DRB).
d). The UDC configuration is carried in PDCP-config.
e). The UDC configuration includes at least one of the buffer size or the dictionary.
f). The UDC configuration may be configured simultaneously with the EHC and/or the ROHC, or may be configured not simultaneously with the EHC and/or the ROHC.
g). If configuration information of DAPS is configured for the UE, information for indicating whether UDC is supported for use during DAPS HO may also be configured for the UE. If it is indicated that the UDC is supported for use during DAPS HO, in this case, a source base station and a target base station need to transmit the UDC buffer state, the UDC synchronization status or the UDC context during the DAPS HO process (such as in a handover preparation message). Optionally, this function is used when configuring whether the UDC continues.
h). The UDC configuration may include an indication of whether the UDC continues. For example, the UDC configuration may include an indication of whether the UDC continues when the PDCP reestablishment is performed, for example, the DRB-ContinueUDC or the DRB-ContinueUDC-UL.

Exemplarily, if such a parameter is not configured, when the PDCP reestablishment is performed, for the UDC, the compression buffer is reset to all 0 or the pre-defined dictionary; and/or, the UDC is used to decompress all stored PDCP SDUs; and/or, the compression buffer is reset to all 0 or the pre-defined dictionary after the UDC is used to decompress all stored PDCP SDUs. If such a parameter is configured, when the PDCP reestablishment is performed, for the UDC, the compression buffer does not need to be reset; the decompression buffer does not need to be reset. When configuring the UDC, the RLC mode corresponding to the bearer and/or logical channel and/or RLC corresponding to the UDC is the AM, and exemplarily, when configuring, RLC-BearerConfig or RLC-Config is used for configuration; and/or, when configuring the UDC, the RLC mode corresponding to the bearer and/or logical channel and/or RLC corresponding to the UDC is the UM, and the UM is bi-directional (i.e., um-Bi-Directional), and exemplarily, when configuring, RLC-BearerConfig or RLC-Config is used for configuration.
j). For the UDC or uplink data compression, the function or field is configured only for a bi-directional DRB (this field can only be configured for a bi-directional DRB).

After receiving the UDC configuration transmitted by the network device, the UE performs the UDC function or the related operation. Exemplarily, if the UDC configuration includes the indication of whether the UDC continues (for example, the indication of whether the UDC continues when the PDCP reestablishment is performed), such as DRB-ContinueUDC or DRB-ContinueUDC-UL, then:
if such a parameter is not configured, when the PDCP reestablishment is performed, for the UDC, the compression buffer is reset to all 0 or the pre-defined dictionary; and/or, the UDC is used to decompress all stored PDCP SDUs; and/or, the compression buffer is reset to all 0 or the pre-defined dictionary (for example, after the UDC is used to decompress all stored PDCP SDUs); if such parameter is configured, when the PDCP reestablishment is performed, for the UDC, the compression buffer does not need to be reset, and the decompression buffer does not need to be reset.

In this embodiment, the UDC function is made available for use in the NR system, and usage restrictions or usage manners of the UDC function are clarified.

### Embodiment 2

in this embodiment, the network device may simultaneously configure the UDC and at least one of the EHC or the ROHC for the compression and/or decompression processing. In this case, the SDAP header and the SDAP control PDU are not compressed.

Exemplarily, the implementation process of the compression end may include the following steps.

### Step 1:

the network device transmits compression configuration to the UE.

Exemplarily, the compression configuration includes one of: the UDC and the ROHC; the UDC and the EHC; the UDC and the EHC and the ROHC.

### Step 2:

after receiving the compression configuration transmitted by the network device, the UE performs a UL compression function or a related operation.

Exemplarily, the UL compression function or the related operation may be performed according to at least one of the following a) to e).

a). Compression is not performed on the SDAP header and the SDAP control PDU, or UDC compression is not performed on the SDAP header and the SDAP control PDU.

b). The compression function or the decompression function may include at least one of the following.

Alt1: the EHC is used for the Ethernet frame header (EHC for Ethernet header), the ROHC is used for the IP header (ROHC for IP header), and the UDC is used for the payload (UDC for payload).

Alt2: the EHC is used for the Ethernet frame header (EHC for Ethernet header).

Optionally, the UDC is used for the payload (UDC for payload).

Optionally, the UDC is used for the IP header and the payload (UDC for IP header and payload).

Alt3: the ROHC is used for the IP header (ROHC for IP header).

Optionally, the UDC is used for the payload (UDC for payload).

Optionally, the UDC is used for the Ethernet frame header and the payload (UDC for Ethernet header and payload).

Alt4: the UDC is used for all (UDC for all).

Optionally, the all includes the Ethernet frame header, the IP header and the payload (including: Ethernet header, IP header, payload).

c). The compression performing sequence may include any of the following.

Alt1: the compression end first performs the EHC compression, then performs the ROHC compression, and then performs the UDC compression.

Optional, it configures the UDC/EHC/ROHC (supporting to simultaneously configure the EHC and other compression mechanisms).

Alt2: the compression end first performs the EHC compression and then performs the UDC compression.

Optionally, the compression end bypasses the ROHC. For example, this packet is an Ethernet packet of non-IP.

Optionally, compression of an IP packet header is also performed by the UDC compression (e.g., IP over Ethernet).

Optional, only the EHC and the UDC are configured, or the UDC/the EHC/the ROHC is configured.

Optionally, this case also includes that the UDC and other header compression mechanisms (ROHC) are configured not simultaneously.

Alt3: the compression end performs the ROHC compression, and then performs the UDC compression.

Optionally, this packet is an IP packet or a non-Ethernet packet.

Optionally, only the ROHC and the UDC are configured.

Optionally, if the packet is an Ethernet packet, the compression end first performs the UDC (for Ethernet header), and then performs the ROHC and the UDC (for data).

Optionally, only the ROHC and the UDC are configured, or the UDC/the EHC/the ROHC is configured.

Optionally, this case also includes that the UDC and other header compression mechanisms (EHC) are configured not simultaneously.

Alt4: the compression end only performs the UDC compression.

Optionally, the Ethernet packet header, the IP packet header, and the data portion are all compressed by the UDC.

Optionally, this packet is the IP packet, the Ethernet packet (without/with IP).

Optionally, one of the following is configured: the UDC; the UDC and the ROHC; the UDC and the EHC; the UDC and the EHC and the ROHC.

Optionally, this case also includes that the UDC and other header compression mechanisms (EHC/ROHC) are configured not simultaneously.

d). Correspondingly, the performing sequence of the decompression end may include any of the following.

Alt1: The decompression end first performs the EHC decompression, then performs the ROHC decompression, and then performs the UDC decompression.

Optionally, the UDC/the EHC/the ROHC is configured (simultaneous configuration is supported).

Alt2: The decompression end first performs the EHC decompression and then performs the UDC decompression.

Optionally, the decompression end bypasses the ROHC. For example, this packet is an Ethernet packet of non-P.

Optionally, decompression of the IP packet header is also performed by the UDC decompression

Optionally, only the EHC and the UDC are configured, or the UDC/the EHC/the ROHC is configured.

Optionally, this case also includes that the UDC and other header compression mechanisms (ROHC) are configured not simultaneously.

Alt3: the decompression end performs the ROHC decompression and then performs the UDC decompression.

Optionally, this packet is the IP packet or the non-Ethernet packet.

Optionally, only the ROHC and the UDC are configured.

Optionally, if the packet is the Ethernet packet, the decompression end first performs the UDC decompression (for Ethernet header), and then performs the ROHC decompression and the UDC decompression (for data portion).

Optionally, only the ROHC and the UDC are configured, or the UDC/the EHC/the ROHC is configured.

Optionally, this case also includes that the UDC and other header compression mechanisms (EHC) are configured not simultaneously.

Alt4: The decompression end only performs the UDC decompression.

Optionally, the Ethernet packet header, the IP packet header, and the data portion are all decompressed by the UDC.

Optionally, this packet is the IP packet, the Ethernet packet (without/with IP).

Optionally, one of the following is configured: the UDC; the UDC and the ROHC; the UDC and the EHC; the UDC and the EHC and the ROHC.

Optionally, this case also includes that the UDC and other header compression mechanisms (EHC/ROHC) are configured not simultaneously.

e). A location of the packet header in the PDCP data PDU may be determined according to the compression order or decompression order, in Alt1 to Alt4.

Optionally, for Alt1, the location of the packet header in the PDCP data PDU is as shown in FIG. 5A.

Optionally, for Alt2, the location of the packet header in the PDCP data PDU is as shown in FIG. 6A.

Optionally, for Alt3, the location of the packet header in the PDCP data PDU is as shown in FIG. 7A.

Optionally, for Alt4, the location of the packet header in the PDCP data PDU is as shown in FIG. 8A.

In this embodiment, for the case in which the SDAP packet header and SDAP control PDU are not compressed, the compression or decompression method when multiple compression mechanisms are configured simultaneously, is designed, which can improve system performance of the communication device.

### Embodiment 3

in this embodiment, the network device simultaneously configures the UDC and at least one of the EHC or the ROHC for the compression and/or decompression processing. In this case, the UDC compression is performed on the SDAP header. Further, the UDC is used to perform the compression of the SDAP control PDU.

Exemplarily, the implementation process is as follows.

Exemplarily, the implementation process of the compression end may include the following steps.

### Step 1:

the network device transmits compression configuration to the UE.

Exemplarily, the compression configuration includes one of: the UDC and the ROHC; the UDC and the EHC; the UDC and the EHC and the ROHC.

### Step 2:

after receiving the compression configuration transmitted by the network device, the UE performs a UL compression function or a related operation.

Exemplarily, the UL compression function or the related operation may include at least one of the following.

a). Compressing the SDAP header, or performing the UDC compression on the SDAP header.

b). Compressing the SDAP control PDU, or performing the UDC compression on the SDAP control PDU.

c). The compression function or decompression function may include at least one of the following.

Alt1: the EHC is used for the Ethernet frame header (EHC for Ethernet header), the ROHC is used for the IP header (ROHC for IP header).

Optionally, the UDC is used for the payload and the SDAP header (UDC for payload and SDAP header).

Alt2: the EHC is used for the Ethernet frame header (EHC for Ethernet header).

Optionally, the UDC is used for the payload and the SDAP header (UDC for payload and SDAP header).

Optionally, the UDC is used for the IP header, the payload and the SDAP header (UDC for IP header, and SDAP header and payload).

Alt3: the ROHC is used for the IP header (ROHC for IP header).

Optionally, the UDC is used for the payload and the SDAP header (UDC for payload and SDAP header).

Optionally, the UDC is used for the Ethernet frame header, the payload and the SDAP header (UDC for Ethernet header, and SDAP header and payload).

Alt4: the UDC is used for all (UDC for all).

Optionally, the all includes the Ethernet frame header, the SDAP header, the IP header and the payload (including: Ethernet header, SDAP header, IP header, payload).

Optionally, the all includes the SDAP header and the payload (including: SDAP header and payload), for example, the SDAP control PDU.

d). The compression performing sequence may include any of the following.

Alt1: the compression end first performs the UDC compression (UDC header+data block: for SDAP header), then performs the EHC compression, then performs the ROHC compression, and then performs the UDC compression.

Optionally, the UDC/the EHC/the ROHC is configured (supporting to configure the EHC and other compression mechanisms simultaneously).

Optionally, performing UDC on the SDAP control PDU is supported.

Optionally, if it is the SDAP control PDU, the compression end bypasses the EHC and ROHC compression. A final format is PDCP header+UDC header+UDC data block. Further, the compression end transmits the packet on which only the UDC is performed, to a lower layer.

Alt2: the compression end first performs the UDC compression (UDC header+data block: for SDAP header), then performs the EHC compression, and then performs the UDC compression.

Optionally, the compression end bypasses the ROHC. For example, this packet is an Ethernet packet of non-IP.

Optionally, compression of the IP packet header is also performed by the UDC compression (e.g., IP over Ethernet).

Optionally, only the EHC and the UDC are configured, or the UDC/the EHC/the ROHC is configured.

Optionally, this case also includes that the UDC and other header compression mechanisms (ROHC) are configured not simultaneously.

Optionally, performing the UDC on the SDAP control PDU is supported.

Optionally, if it is the SDAP control PDU, the compression end bypasses the EHC compression. A final format is PDCP header+UDC header+UDC data block. Further, the compression end transmits the packet on which only the UDC is performed, to the lower layer.

Alt3: the compression end performs the UDC compression (UDC header+data block: for SDAP header), then performs the ROHC compression, and then performs the UDC compression.

Optionally, this packet is the IP packet or the non-Ethernet packet.

Optionally, only the ROHC and the UDC are configured.

Optionally, if the packet is the Ethernet packet, the compression end first performs the UDC (for Ethernet header), and then performs the ROHC and the UDC (for data).

Optionally, only the ROHC and the UDC are configured, or the UDC/the EHC/the ROHC is configured.

Optionally, this case also includes that the UDC and other header compression mechanisms (EHC) are configured not simultaneously.

Optionally, performing the UDC on the SDAP control PDU is supported.

Optionally, if it is the SDAP control PDU, the compression end bypasses the ROHC compression. A final format is PDCP header+UDC header+UDC data block. Further, the compression end transmits the packet on which only the UDC is performed, to the lower layer.

Alt4: the compression end only performs the UDC compression.

Optionally, the SDAP header, the Ethernet packet header, the IP packet header, and the data portion are all compressed by the UDC.

Optionally, the packet is the IP packet, the Ethernet packet (without/with IP).

Optionally, one of the following is configured: the UDC; the UDC and the ROHC; the UDC and the EHC; the UDC and the EHC and the ROHC.

Optionally, this case also includes that the UDC and other header compression mechanisms (EHC/ROHC) are configured not simultaneously.

Optionally, performing the UDC on the SDAP control PDU is supported.

Optionally, if it is the SDAP control PDU, the compression end bypasses the ROHC and/or EHC compression. A final format is PDCP header+UDC header+UDC data block. Further, the compression end transmits the packet on which only the UDC is performed, to a lower layer.

Alt5: the compression end first performs the EHC and/or the ROHC, and then performs the UDC compression.

Optionally, for the UDC, it may be used for all remaining portions (for all remaining), may cover the SDAP header and the payload (may cover SDAP header and payload).

Optionally, indication information is carried in the UDC PDU or UDC PDU header, to indicate whether the SDAP header is compressed.

e). Correspondingly, the performing sequence of the decompression end may include any of the following.

Alt1: the decompression end first performs the UDC decompression (UDC header+data block: for SDAP header), then performs the EHC decompression, then performs the ROHC decompression, and then performs the UDC decompression.

Optionally, the UDC/the EHC/the ROHC is configured (simultaneous configuration is supported).

Optionally, performing the UDC on the SDAP control PDU is supported.

Optionally, if it is the SDAP control PDU, the decompression end bypasses the EHC decompression and the ROHC decompression. Further, the packet on which the UDC decompression is performed, is transmitted to a higher layer.

Alt2: the decompression end first performs the UDC decompression (UDC header+data block: for SDAP header), performs the EHC decompression, and then performs the UDC decompression.

Optionally, the decompression end bypasses the ROHC. For example, this packet is an Ethernet packet of non-IP.

Optionally, the decompression of the IP packet header is also performed by the UDC decompression.

Optionally, only the EHC and the UDC are configured, or the UDC/the EHC/the ROHC is configured.

Optionally, this case also includes that the UDC and other header compression mechanisms (ROHC) are configured not simultaneously.

Optionally, performing the UDC on the SDAP control PDU is supported.

Optional, if it is the SDAP control PDU, the decompression end bypasses the EHC decompression. Further, the packet on which the UDC decompression is performed, is transmitted to a higher layer.

Alt3: the decompression end performs the UDC decompression (UDC header+data block: for SDAP header), then performs the ROHC decompression, and then performs the UDC decompression.

Optionally, this packet is the IP packet or the non-Ethernet packet.

Optionally, only the ROHC and the UDC are configured.

Optionally, if the packet is the Ethernet packet, the decompression end first performs the UDC decompression (for Ethernet header), and then performs the ROHC decompression and the UDC decompression (for data portion).

Optionally, only the ROHC and the UDC are configured, or the UDC/the EHC/the ROHC is configured.

Optionally, this case also includes that the UDC and other header compression mechanisms (EHC) are configured not simultaneously.

Optionally, performing the UDC on the SDAP control PDU is supported.

Optionally, if it is the SDAP control PDU, the decompression end bypasses the ROHC decompression. Further, the packet on which the UDC decompression is performed, is transmitted to a higher layer.

Alt4: the decompression end only performs the UDC decompression.

Optionally, the Ethernet packet header, the IP packet header, and the data portion are all decompressed by the UDC.

Optional, the packer is the IP packet, the Ethernet packet (without/with IP).

Optionally, one of the following is configured: the UDC; the UDC and the ROHC; the UDC and the EHC; the UDC and the EHC and the ROHC.

Optionally, this case also includes that the UDC and other header compression mechanisms (EHC/ROHC) are configured not simultaneously.

Optionally, performing the UDC on the SDAP control PDU is supported.

Optionally, if compression other than the UDC is also configured and it is the SDAP control PDU, the decompression end bypasses the EHC decompression and the ROHC decompression.

Further, the packet on which the UDC decompression is performed, is transmitted to a higher layer.

Alt5: the decompression end first performs the EHC and/or ROHC decompression, and then performs the UDC decompression.

Optionally, for the UDC, it may be used for all remaining portions (for all remaining), may cover the SDAP header and the payload (may cover SDAP header and payload).

Optionally, the decompression end, after decompressing the SDAP header, puts it back before the Ethernet and/or IP packet header.

Optionally, according to indication information carried in the UDC PDU or UDC PDU header, the UDC decompression end determines whether the SDAP header of the DRB or PDCP PDU is compressed, and/or, determines whether to put the decompressed SDAP header back before the Ethernet and/or IP packet header.

f). A location of the packet header in the PDCP data PDU may be determined according to the compression order or decompression order, in Alt1 to Alt5.

Optionally, for Alt1, the location of the packet header in the PDCP data PDU is as shown in FIG. 5B.

Optionally, for Alt2, the location of the packet header in the PDCP data PDU is as shown in FIG. 6B.

Optionally, for Alt3, the location of the packet header in the PDCP data PDU is as shown in FIG. 7C or FIG. 7D.

Optionally, for Alt4, the location of the packet header in the PDCP data PDU is as shown in FIG. 8B.

Optionally, for Alt5, the location of the packet header in the PDCP data PDU is as shown in FIG. 5C or FIG. 5D.

In this embodiment, for the case in which the SDAP packet header and the SDAP control PDU are compressed, the compression or decompression method when multiple compression mechanisms are configured simultaneously, is designed, which can improve system performance of the communication device.

The embodiments of the present application are described in detail above in combination with the accompanying drawings. However, the present application is not limited to specific details in the above embodiments. Within a range of a technical conception of the present application, a variety of simple modifications may be made to the technical solutions of the present application, and these simple modifications all belong to the protection scope of the present application. For example, each technical feature described in the above-mentioned embodiments may be combined in any suitable way without conflict, and in order to avoid unnecessary repetition, the various possible combinations are not otherwise described in the present application. For another example, any combination between the various different embodiments of the present application is also possible, as long as they are not inconsistent with the idea of the present application, they should also be regarded as the content disclosed in the present application.

It should also be understood that, in the various method embodiments of the present application, the size of the sequence numbers of the above-mentioned processes does not mean an order of execution, the order of execution of the processes shall be determined by their functions and inherent logic, and shall not constitute any limitation on the implementation processes of the embodiments of the present application. In addition, in the embodiments of the present application, the terms “downlink” and “uplink” are used to represent transmission directions of signal or data, where the “downlink” is used to represent that the transmission direction of signal or data is a first direction transmitting from a site to a user equipment of a cell, and the “uplink” is used to represent that the transmission direction of signal or data is a second direction transmitting from the user equipment of the cell to the site, for example, “downlink signal” represents that the transmission direction of the signal is the first direction. In addition, in the embodiments of the present application, the term “and/or” is only an association relationship describing associated objects, and represents that three relationships may exist. For example, “A and/or B” may represent three cases: only A, both A and B, or only B. In addition, the character “/” herein generally represents that associated objects before and after “/” are in an “or” relationship.

The method embodiments of the present application have been described in detail above with reference to FIG. 1 to FIG. 8B, and apparatus embodiments of the present application are described in detail below with reference to FIG. 9 to FIG. 11.

FIG. 9 is a schematic block diagram of a communication device 300 of the embodiments of the present application.

As shown in FIG. 9, the communication device 300 may include:
a processing unit 310, configured to perform a compression or decompression operation on a first data packet based on at least one compression protocol; where the at least one compression protocol includes the uplink data compression (UDC) protocol.

In some embodiments, the at least one compression protocol further includes at least one of the following protocols: an Ethernet frame header compression (EHC) protocol, or a robust header compression (ROHC) protocol.

In some embodiments, a service data adaptation protocol (SDAP) header in the first data packet is not compressed; and/or, when the first data packet is an SDAP control protocol data unit (PDU), the SDAP control PDU is not compressed.

In some embodiments, a service data adaptation protocol (SDAP) header in the first data packet is compressed; and/or, when the first data packet is an SDAP control protocol data unit (PDU), the SDAP control PDU is compressed.

In some embodiments, the processing unit 310 is further configured to:
based on the UDC protocol, perform the compression or decompression operation on the SDAP header in the first data packet.

In some embodiments, the processing unit 310 is further configured to:
when the first data packet is the SDAP control PDU, perform the compression or decompression operation on the first data packet as a whole based on the UDC protocol.

In some embodiments, the first data packet or a compressed packet of the first data packet includes a PDCP header, a UDC header and a data block in sequence.

In some embodiments, the processing unit 310 is further configured to:
when at least one of the following is met, perform the compression or decompression operation on the first data packet as a whole based on the UDC protocol:
the compression or decompression operation being performed on the SDAP header;
the compression or decompression operation being performed on the SDAP control PDU;
UDC configuration being configured;
the UDC configuration and ROHC configuration being configured;
the UDC configuration and EHC configuration being configured;
the UDC configuration, the EHC configuration and the ROHC configuration being configured;
the UDC configuration and the ROHC configuration being configured not simultaneously;
the UDC configuration and the EHC configuration being configured not simultaneously; first indication information being indicated or configured, where the first indication information is used to indicate whether to perform the compression or decompression operation on the SDAP header and/or the SDAP control PDU;
second indication information being indicated or configured, where the second indication information is used to indicate a filed or information of performing a UDC compression or decompression operation;
a predefined rule indicating that the compression or decompression operation is not performed on the SDAP header and/or the SDAP control PDU; or
a predefined rule indicating that the compression or decompression operation is performed on the SDAP header and/or the SDAP control PDU.

In some embodiments, the first data packet is a PDCP PDU or a PDCP service data unit (SDU).

In some embodiments, the UDC protocol is used to compress at least one of: an SDAP header, an Ethernet frame header, an IP header, a payload, a remaining portion of the first data packet except a packet header, or an uncompressed remaining portion of the first data packet.

In some embodiments, an EHC protocol in the at least one compression protocol is used to compress an Ethernet frame header; and/or, an ROHC protocol in the at least one compression protocol is used to compress an Internet protocol (IP) header; and/or, the UDC protocol is used to compress a payload and/or an uncompressed remaining portion of the first data packet.

In some embodiments, the uncompressed remaining portion of the first data packet includes: an uncompressed remaining portion of the first data packet except a packet header.

In some embodiments, the first data packet or a compressed packet of the first data includes at least one of: a PDCP header, an SDAP header, an EHC header, an ROHC header, a UDC header or a data block.

In some embodiments, the processing unit 310 is further configured to:
perform the compression or decompression operation on the first data packet based on at least one of the EHC protocol, the ROHC protocol or the UDC protocol.

In some embodiments, the processing unit 310 is further configured to:
when at least one of the following is met, perform the compression or decompression operation on the first data packet based on at least one of the EHC protocol, the ROHC protocol, or the UDC protocol:
UDC configuration, EHC configuration and ROHC configuration being configured;
the UDC configuration and the ROHC configuration being configured simultaneously;
the UDC configuration and the EHC configuration being configured simultaneously; or
the first data packet including at least one of the Ethernet frame header, the IP header, or the payload.

In some embodiments, the processing unit 310 is further configured to:
when the compression or decompression operation is not performed on a service data adaptation protocol (SDAP) header in the first data packet, perform the compression or decompression operation on the first data packet based on the EHC protocol, the ROHC protocol and the UDC protocol in sequence;
where the first data packet or a compressed packet of the first data packet includes at least one of the following in sequence: a PDCP header, an SDAP header, an EHC header, an ROHC header, a UDC header or a data block.

In some embodiments, the processing unit 310 is further configured to:
when the compression or decompression operation is performed on a service data adaptation protocol (SDAP) header in the first data packet, after performing the compression or decompression operation on the SDAP header based on the UDC protocol, perform the compression or decompression operation on the first data packet based on the EHC protocol, the ROHC protocol and the UDC protocol in sequence;
where the first data packet or a compressed packet of the first data packet includes at least one of the following in sequence: a PDCP header, a first UDC header, an EHC header, an ROHC header, a second UDC header, or a data block.

In some embodiments, the first UDC header includes a data block.

In some embodiments, the processing unit 310 is further configured to:
when the compression or decompression operation is performed on a service data adaptation protocol (SDAP) header in the first data packet, perform the compression or decompression operation on the first data packet based on the EHC protocol, the ROHC protocol and the UDC protocol in sequence;
where the first data packet or a compressed packet of the first data packet includes at least one of the following in sequence: a PDCP header, an EHC header, an ROHC header, a UDC header or a data block.

In some embodiments, the processing unit 310 is further configured to:
when the compression or decompression operation is performed on a service data adaptation protocol (SDAP) header in the first data packet, perform the compression or decompression operation on the first data packet based on the ROHC protocol, the EHC protocol and the UDC protocol in sequence;
where the first data packet or a compressed packet of the first data packet includes at least one of the following in sequence: a PDCP header, an ROHC header, an EHC header, a UDC header or a data block.

In some embodiments, an EHC protocol in the at least one compression protocol is used to compress an Ethernet frame header; and/or, the UDC protocol is used to compress at least one of: a payload, an Internet protocol (IP) header, or a remaining portion of the first data packet except a packet header.

In some embodiments, the first data packet or a compressed packet of the first data includes at least one of: a PDCP header, an SDAP header, an EHC header, a UDC header or a data block.

In some embodiments, the processing unit 310 is further configured to:
perform the compression or decompression operation on the first data packet based on at least one of the EHC protocol or the UDC protocol.

In some embodiments, the processing unit 310 is further configured to:
when at least one of the following is met, perform the compression or decompression operation on the first data packet based on at least one of the EHC protocol or the UDC protocol:
the first data packet being a non-IP Ethernet frame packet;
the compression or decompression operation being performed on an IP header in the first data packet based on the UDC protocol;
UDC configuration and EHC configuration being configured;
the UDC configuration, the EHC configuration and ROHC configuration being configured;
the UDC configuration and the ROHC configuration being configured not simultaneously; or
the first data packet including at least one of the Ethernet frame header, the IP header, or the payload.

In some embodiments, the processing unit 310 is further configured to:
when the compression or decompression operation is not performed on a service data adaptation protocol (SDAP) header in the first data packet, perform the compression or decompression operation on the first data packet based on the EHC protocol and the UDC protocol in sequence;
where the first data packet or a compressed packet of the first data packet includes at least one of the following in sequence: a PDCP header, an SDAP header, an EHC header, a UDC header or a data block.

In some embodiments, the processing unit 310 is further configured to:
when the compression or decompression operation is performed on a service data adaptation protocol (SDAP) header in the first data packet, after performing the compression or decompression operation on the SDAP header based on the UDC protocol, perform the compression or decompression operation on the first data packet based on the EHC protocol and the UDC protocol in sequence;
where the first data packet or a compressed packet of the first data packet includes at least one of the following in sequence: a PDCP header, a third UDC header, an EHC header, a fourth UDC header, or a data block.

In some embodiments, the third UDC header includes a data block.

In some embodiments, the processing unit 310 is further configured to:
when the compression or decompression operation is performed on a service data adaptation protocol (SDAP) header in the first data packet, perform the compression or decompression operation on the first data packet based on the EHC protocol and the UDC protocol in sequence;
where the first data packet or a compressed packet of the first data packet includes at least one of the following in sequence: a PDCP header, an EHC header, a UDC header, or a data block.

In some embodiments, an ROHC protocol in the at least one compression protocol is used to compress an Internet protocol (TP) header; and/or, the UDC protocol is used to compress at least one of: a payload, an Ethernet frame header, or a remaining portion of the first data packet except a packet header.

In some embodiments, the first data packet or a compressed packet of the first data includes at least one of: a PDCP header, an SDAP header, an ROHC header, a UDC header or a data block.

In some embodiments, the processing unit 310 is further configured to:
perform the compression or decompression operation on the first data packet based on at least one of the ROHC protocol or the UDC protocol.

In some embodiments, the processing unit 310 is further configured to:
when at least one of the following is met, perform the compression or decompression operation on the first data packet based on at least one of the ROHC protocol or the UDC protocol:
the first data packet being an IP packet;
the first data packet being a non-Ethernet frame packet;
the compression or decompression operation being performed on an IP header in the first data packet based on the UDC protocol;
UDC configuration and ROHC configuration being configured;
the UDC configuration, the ROHC configuration and EHC configuration being configured;
the UDC configuration and the EHC configuration being configured not simultaneously;
or
the first data packet including at least one of the Ethernet frame header, the IP header, or the payload.

In some embodiments, the processing unit 310 is further configured to:
when the compression or decompression operation is not performed on a service data adaptation protocol (SDAP) header in the first data packet, perform the compression or decompression operation on the first data packet based on the ROHC protocol and the UDC protocol in sequence;
where the first data packet or a compressed packet of the first data packet includes at least one of the following in sequence: a PDCP header, an SDAP header, an ROHC header, a UDC header or a data block.

In some embodiments, the processing unit 310 is further configured to:
when the first data packet is an Ethernet frame packet, and the compression or decompression operation is not performed on a service data adaptation protocol (SDAP) header in the first data packet, after performing the compression or decompression operation on the Ethernet frame header in the first data packet based on the UDC protocol, perform the compression or decompression operation on the first data packet based on the ROHC protocol and the UDC protocol in sequence;
where the first data packet or a compressed packet of the first data packet includes at least one of the following in sequence: a PDCP header, an SDAP header, a fifth UDC header, an ROHC header, a sixth UDC header, or a data block.

In some embodiments, the fifth UDC header includes a data block.

In some embodiments, the processing unit 310 is further configured to:
when the first data packet is an Ethernet frame packet, and the compression or decompression operation is not performed on a service data adaptation protocol (SDAP) header in the first data packet, perform the compression or decompression operation on the first data packet based on the ROHC protocol and the UDC protocol in sequence;
where the first data packet or a compressed packet of the first data packet includes at least one of the following in sequence: a PDCP header, an SDAP header, an ROHC header, a UDC header or a data block.

In some embodiments, the processing unit 310 is further configured to:
when the compression or decompression operation is performed on a service data adaptation protocol (SDAP) header in the first data packet, after performing the compression or decompression operation on the SDAP header based on the UDC protocol, perform the compression or decompression operation on the first data packet based on the ROHC protocol and the UDC protocol in sequence;
where the first data packet or a compressed packet of the first data packet includes at least one of the following in sequence: a PDCP header, a seventh UDC header, an ROHC header, an eighth UDC header, or a data block.

In some embodiments, the seventh UDC header includes a data block.

In some embodiments, the processing unit 310 is further configured to:
when the first data packet is an Ethernet frame packet, and the compression or decompression operation is performed on a service data adaptation protocol (SDAP) header in the first data packet, after performing the compression or decompression operation on the SDAP header and the Ethernet frame header in the first data packet based on the UDC protocol, perform the compression or decompression operation on the first data packet based on the ROHC protocol and the UDC protocol in sequence;
where the first data packet or a compressed packet of the first data packet includes at least one of the following in sequence: a PDCP header, a ninth UDC header, an ROHC header, a tenth UDC header, or a data block.

In some embodiments, the ninth UDC header includes a data block.

In some embodiments, the processing unit 310 is further configured to:
when the first data packet is an Ethernet frame packet, and the compression or decompression operation is performed on a service data adaptation protocol (SDAP) header in the first data packet, perform the compression or decompression operation on the first data packet based on the ROHC protocol and the UDC protocol in sequence;
where the first data packet or a compressed packet of the first data packet includes at least one of the following in sequence: a PDCP header, an ROHC header, a UDC header or a data block.

In some embodiments, the UDC protocol is used to compress at least one of: an Internet protocol (TP) header, a payload, an Ethernet frame header, or a remaining portion of the first data packet except a packet header.

In some embodiments, the first data packet or a compressed packet of the first data packet includes at least one of: a PDCP header, an SDAP header, a UDC header or a data block.

In some embodiments, the packet header includes at least one of: a PDCP header, an SDAP header, an Ethernet frame header, or an IP header.

In some embodiments, the processing unit 310 is further configured to:
perform the compression or decompression operation on the first data packet based on the UDC protocol.

In some embodiments, the processing unit 310 is further configured to:
when at least one of the following is met, perform the compression or decompression operation on the first data packet based on the UDC protocol: the compression or decompression operation being performed on the Ethernet frame header, the IP header and a data portion in the first data packet based on the UDC protocol;
the compression or decompression operation being performed on the data portion in the first data packet based on the UDC protocol;
the first data packet being an IP packet;
the first data packet being an Ethernet frame packet;
UDC configuration being configured;
the UDC configuration and ROHC configuration being configured;
the UDC configuration and EHC configuration being configured;
the UDC configuration, the EHC configuration and the ROHC configuration being configured;
the UDC configuration and the ROHC configuration being configured not simultaneously;
the UDC configuration and the EHC configuration being configured not simultaneously;
or
the first data packet including at least one of the Ethernet frame header, the IP header, or the payload.

In some embodiments, the processing unit 310 is further configured to:
when the compression or decompression operation is not performed on a service data adaptation protocol (SDAP) header in the first data packet, perform the compression or decompression operation on the first data packet based on the UDC protocol;
where the first data packet or a compressed packet of the first data packet includes at least one of the following in sequence: a PDCP header, an SDAP header, a UDC header, or a data block.

In some embodiments, the processing unit 310 is further configured to:
when the compression or decompression operation is performed on a service data adaptation protocol (SDAP) header in the first data packet, perform the compression or decompression operation on the first data packet based on the UDC protocol;
where the first data packet or a compressed packet of the first data packet includes at least one of following in sequence: a PDCP header, a UDC header or a data block.

In some embodiments, the first data packet or a compressed packet of the first data packet includes third indication information, and the third indication information is used to indicate at least one of:
whether an SDAP header is compressed;
a number of bits occupied by the SDAP header or a number of bits occupied by a compressed SDAP header; or
a starting position or an ending position occupied by the compressed SDAP header.

In some embodiments, the third indication information is carried in a PDCP PDU or a UDC PDU or a UDC header.

In some embodiments, the first data packet or a compressed packet of the first data packet includes fourth indication information, and the fourth indication information is used to indicate at least one of:
whether an Ethernet frame header is compressed;
a number of bits occupied by the Ethernet frame header or a number of bits occupied by a compressed Ethernet frame header; or
a starting position or an ending position occupied by the compressed Ethernet frame header.

In some embodiments, the fourth indication information is carried in a PDCP PDU or a UDC PDU or a UDC header.

In some embodiments, the first data packet or a compressed packet of the first data packet includes fifth indication information, and the fifth indication information is used to at least one of:
whether an IP header is compressed;
a number of bits occupied by the IP header or a number of bits occupied by a compressed IP header; or
a starting position or an ending position occupied by the compressed IP header.

In some embodiments, the fifth indication information is carried in a PDCP PDU or a UDC PDU or a UDC header.

In some embodiments, the first data packet or a compressed packet of the first data packet includes sixth indication information, and the sixth indication information is used to indicate whether to bypass an IP protocol and/or an ROHC protocol.

In some embodiments, the sixth indication information is carried in a PDCP PDU or a UDC PDU or a UDC header.

In some embodiments, the first data packet or a compressed packet of the first data packet includes seventh indication information, and the seventh indication information is used to indicate whether to bypass an Ethernet frame protocol and/or an EHC protocol.

In some embodiments, the seventh indication information is carried in a PDCP PDU or a UDC PDU or a UDC header.

In some embodiments, the communication device may further include:
a communication unit configured to, receive or transmit UDC configuration, where the UDC configuration meets at least one of:
both a network device and a terminal device being entities that support a new radio (NR) version;
the network device being a base station in an NR system;
the UDC configuration being configured for a data radio bearer (DRB) and/or the terminal device;
the UDC configuration being carried in packet data convergence protocol (PDCP) configuration;
the UDC configuration being carried in bearer configuration;
the UDC configuration including at least one of a buffer size or a dictionary; the UDC configuration being configured simultaneously with at least one of the following configuration: EHC configuration, or ROHC configuration;
the UDC configuration being configured not simultaneously with at least one of the following configuration: EHC configuration, or ROHC configuration;
the UDC configuration being configured not simultaneously with at least one of the following configuration: dual active protocol stack (DAPS) configuration, control handover (CHO) configuration, out-of-order transmission configuration, repetition configuration, or furcation transmission configuration;
the UDC configuration being configured simultaneously with at least one of the following configuration: DAPS configuration, repetition configuration, or furcation transmission configuration;
radio resource control (RRC) configuration, PDCP configuration, DAPS configuration or the UDC configuration including eighth indication information, and the eighth indication information being used to indicate whether a dual active protocol stack handover (DAPS HO) supports the UDC configuration;
the RRC configuration, the PDCP configuration, the DAPS configuration or the UDC configuration including ninth indication information, and the ninth indication information being used to indicate whether to continue to use the UDC configuration, or to indicate whether to continue to use the UDC configuration when PDCP reestablishment is performed;
a radio link control (RLC) mode corresponding to the UDC configuration being an acknowledged mode (AM);
a RLC mode corresponding to the UDC configuration being a bi-directional unacknowledged mode (UM); or
the UDC configuration or a filed corresponding to the UDC configuration being configured for a bi-directional data radio bearer (DRB).

In some embodiments, the UDC configuration is configured when PDCP reestablishment configuration is configured, and/or, the UDC configuration is configured when the ninth indication information is not configured.

In some embodiments, the radio link control (RLC) mode corresponding to the UDC configuration being the acknowledged mode (AM), includes: the RLC mode corresponding to at least one of the following corresponding to the UDC configuration being the acknowledged mode (AM): a bearer, a logical channel, or RLC.

In some embodiments, the RLC mode corresponding to the UDC configuration being the bi-directional unacknowledged mode (UM), includes: the RLC mode corresponding to at least one of the following corresponding to the UDC configuration being the bi-directional unacknowledged mode (UM): a bearer, a logical channel, or RLC.

In some embodiments, when configuration information of DAPS is configured for the terminal device, the RRC configuration, the PDCP configuration, the DAPS configuration or the UDC configuration includes the eighth indication information.

In some embodiments, the ninth indication information is configured in a case of a radio resource control (RRC) connection being resumed or handover.

In some embodiments, a configured PDCP entity remains unchanged and does not indicate full configuration.

In some embodiments, when a configured bearer is a DAPS bearer, the ninth indication information is not configured.

In some embodiments, the eighth indication information is used to indicate that the DAPS HO supports the UDC configuration.

In some embodiments, at least one of a UDC buffer, a UDC synchronization state, or UDC context information corresponding to the UDC configuration is transmitted by a source network device to a target network device or is transmitted by the terminal device to the target network device.

In some embodiments, the at least one of the UDC buffer, the UDC synchronization state, or the UDC context information corresponding to the UDC configuration being transmitted by the source network device to the target network device or being transmitted by the terminal device to the target network device, includes: when the ninth indication information is used to indicate to continue to use the UDC configuration when the PDCP reestablishment is performed, the at least one of the UDC buffer, the UDC synchronization state, or the UDC context information corresponding to the UDC configuration being transmitted by the source network device to the target network device or is transmitted by the terminal device to the target network device.

In some embodiments, the UDC configuration between the terminal device and a source network device is used before uplink handover in a case of performing the DAPS HO; and/or, the UDC configuration configured by the source network device is used before uplink handover in a case of performing the DAPS HO.

In some embodiments, the UDC configuration between the terminal device and a target network device is used after uplink handover; and/or, the UDC configuration configured by a source network device is used after uplink handover; and/or, the UDC configuration configured by the target network device is used after uplink handover.

In some embodiments, the eighth indication information is used to indicate not to continue to use the UDC configuration; and/or, the eighth indication information is used to indicate not to continue to use the UDC configuration when the PDCP reestablishment is performed; and/or, the eighth indication information is not carried in the RRC configuration, the PDCP configuration, the DAPS configuration or the UDC configuration.

In some embodiments, the processing unit 310 may also be configured to:
perform at least one of:
resetting a compression buffer to all zeros or a pre-defined dictionary;
decompressing all stored PDCP service data units (SDUs) by using the UDC configuration; or
after decompressing all the stored PDCP SDUs by using the UDC configuration, resetting the compression buffer to all zeros or the pre-defined dictionary.

In some embodiments, the processing unit 310 may also be configured to:
in a case where a first condition is met, performing at least one of:
resetting the compression buffer to all zeros or the pre-defined dictionary; decompressing all the stored PDCP service data units (SDUs) by using the UDC configuration; or
after decompressing all the stored PDCP SDUs by using the UDC configuration, resetting the compression buffer to all zeros or the pre-defined dictionary;
where the first condition includes at least one of:
being in a process of performing the DAPS HO;
being in a process of performing the DAPS HO and the eighth indication information
being used to indicate that the DAPS HO does not support the UDC configuration; being in a process of performing the DAPS HO and the ninth indication information being used to indicate not to continue to use the UDC configuration or to indicate not to continue to use the UDC configuration when the PDCP reestablishment is performed; or
being in a process of performing uplink handover.

In some embodiments, the eighth indication information is used to indicate to continue to use the UDC configuration when the PDCP reestablishment is performed; and/or, the eighth indication information is carried in the RRC configuration, the PDCP configuration, the DAPS configuration or the UDC configuration.

In some embodiments, the processing unit 310 may also be configured to:
continue to use a buffer of the UDC configuration without resetting the buffer.

In some embodiments, the communication device may also include:
a communication unit configured to, receive or transmit at least one of the following configuration: ROHC configuration, or EHC configuration.

It should be understood that, the apparatus embodiments and the method embodiments may correspond to each other, and similar descriptions may refer to the method embodiments. In some embodiments, the communication device 300 shown in FIG. 9 may correspond to the corresponding subject in performing the method 200 of the embodiments of the present application, and the aforementioned and other operations and/or functions of various units in the communication device 300 respectively intend to implement the corresponding processes in various method provided in the embodiments of the present application, which will not be repeated here for brevity.

The communication device of the embodiments of the present application is described above from the perspective of functional modules in combination with the accompanying drawings. It should be understood that the functional modules may be implemented in the form of hardware, may also be implemented by instructions in the form of software, or may also be implemented by a combination of hardware and software modules. In some embodiments, each step of the method embodiments in the embodiments of the present application can be completed by an integrated logic circuit of hardware in a processor and/or instructions in the form of software. The steps of the methods disclosed in combination with the embodiments of the present application may be directly embodied as being performed and completed by a hardware decoding processor, or by using a combination of hardware and software modules in the decoding processor. Optionally, the software module may be located in a mature storage medium in the art such as a random memory, a flash memory, a read-only memory, a programmable read-only memory, an electrically erasable programmable memory, a register, etc. The storage medium is located in the memory, and the processor reads information in the memory and completes the steps in the above method embodiments in combination with its hardware.

For example, the processing unit 310 mentioned above may be implemented by a processor.

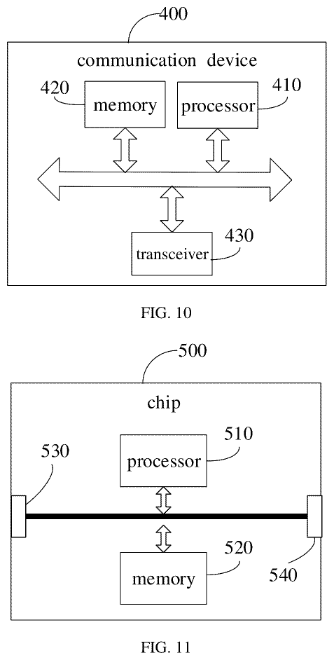

FIG. 10 is a schematic block diagram of the communication device 400 of the embodiments of the present application.

As shown in FIG. 10, the electronic device 400 may include a processor 410.

Herein, the processor 410 may invoke and execute a computer program from a memory to implement the method in the embodiments of the present application.

As shown in FIG. 10, the electronic device 400 may further include a memory 420.

Herein, the memory 420 may be used to store indication information, and may also be used to store codes, instructions, etc., executed by the processor 410. Herein, the processor 410 may invoke and execute the computer program from the memory 420 to implement the method in the embodiments of the present application. The memory 420 may be a separate device independent from the processor 410, or may also be integrated into the processor 410.

As shown in FIG. 10, the communication device 400 may also include a transceiver 430.

Herein, the processor 410 may control the transceiver 430 to communicate with other devices, the transceiver may transmit information or data to other devices, or receive information or data transmitted by other devices. The transceiver 430 may include a transmitter and a receiver. The transceiver 430 may further include antennas, and the number of antennas may be one or more.

It should be understood that, various components in the communication device 400 are connected through a bus system, where the bus system includes a power bus, a control bus and a status signal bus, in addition to a data bus.

It should also be understood that, the communication device 400 may be the communication device in the embodiments of the present application, and the communication device 400 may implement the corresponding processes implemented by the communication device in the various methods of the embodiments of the present application, that is to say, the communication device 400 of the embodiments of the present application may correspond to the communication device 300 in the embodiments of the present application, and may correspond to the corresponding subject in performing the method 200 according to the embodiments of the present application, which will not be repeated here for brevity.

In addition, the embodiments of the present application further provide a chip.

For example, the chip may be an integrated circuit chip that has signal processing capabilities and may implement or execute the various methods, steps and logical block diagrams disclosed in the embodiments of the present application. The chip may also be referred to as a system on chip, a system chip, a chip system or system-on-chip chip, etc. Optionally, the chip may be applied to various communication devices, so that the communication device equipped with the chip can execute the various methods, steps and logical block diagrams disclosed in the embodiments of the present application.

FIG. 11 is a schematic structural diagram of a chip 500 according to the embodiments of the present application.

As shown in FIG. 11, the chip 500 includes a processor 510.

The processor 510 may invoke and execute a computer program from a memory to implement the method in the embodiments of the present application.

As shown in FIG. 11, the chip 500 may further include a memory 520.

Herein, the processor 510 may invoke and execute the computer program from the memory 520 to implement the method in the embodiments of the present application. The memory 520 may be used to store indication information, and may also be used to store codes, instructions, etc., executed by the processor 510. The memory 520 may be a separate device independent from the processor 510, or may also be integrated into the processor 510.

As shown in FIG. 11, the chip 500 may also include an input interface 530.

Herein, the processor 510 may control the input interface 530 to communicate with other devices or chips. In some embodiments, it may acquire information or data transmitted by other devices or chips.

As shown in FIG. 11, the chip 500 may also include an output interface 540.

Herein, the processor 510 may control the output interface 540 to communicate with other devices or chips. In some embodiments, it may output information or data to other devices or chips.

It should be understood that, the chip 500 may be applied to the communication device in the embodiments of the present application, and the chip may implement the corresponding processes implemented by the communication device in the various methods of the embodiments of the present application, which will not be repeated here for brevity. It should also be understood that, various components in the chip 500 are connected through a bus system, where the bus system includes a power bus, a control bus and a status signal bus, in addition to a data bus.

The processor mentioned above may include but be not limited to:
a general-purpose processor, a Digital Signal Processor (DSP), an Application Specific Integrated Circuit (ASIC), a Field Programmable Gate Array (FPGA) or other programmable logic devices, a discrete gate or transistor logic device, a discrete hardware component, etc.

The processor may be used to implement or execute the various methods, steps, and logical block diagrams disclosed in the embodiments of the present application. The steps of the method disclosed in combination with the embodiments of the present application may be directly embodied as being performed and completed by a hardware decoding processor, or by using a combination of hardware and software modules in the decoding processor. The software module may be located in the mature storage medium in the art such as the random memory, the flash memory, the read-only memory, the programmable read-only memory or erasable programmable memory, the register. The storage medium is located in the memory, and the processor reads the information in the memory and completes the steps of the above methods in combination with its hardware.

The memory mentioned above includes but is not limited to:
a volatile memory and/or a non-volatile memory. Herein, the non-volatile memory may be a Read-Only Memory (ROM), a programmable read-only memory (Programmable ROM, PROM), an erasable programmable read-only memory (Erasable PROM, EPROM), an electrically erasable programmable read-only memory (Electrically EPROM, EEPROM) or a flash memory. The volatile memory may be a Random Access Memory (RAM), which is used as an external cache. Through illustrative, rather than limiting, illustration, many forms of RAMs are available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (synch link DRAM, SLDRAM) and a direct rambus random access memory (Direct Rambus RAM, DR RAM).

It should be noted that, the memories described herein are intended to include these and any other suitable types of memories.

The embodiments of the present application further provide a non-transitory computer readable storage medium for storing a computer program. The non-transitory computer readable storage medium stores one or more programs, and the one or more programs include instructions that, when executed by a portable electronic device including a plurality of application programs, can cause the portable electronic device to perform the wireless communication method provided by the present application. Optionally, the non-transitory computer readable storage medium may be applied to the communication device in the embodiments of the present application, and the computer program causes the computer to execute the corresponding processes implemented by the communication device in the various methods of the embodiments of the present application, which will not be repeated here for brevity. The communication device may be the terminal device or the network device, which is not specifically limited in the present application.

The embodiments of the present application further provide a computer program product including a computer program. Optionally, the computer program product may be applied to the communication device in the embodiments of the present application, and the computer program causes the computer to execute the corresponding processes implemented by the communication device in the various methods of the embodiments of the present application, which will not be repeated here for brevity. The communication device may be the terminal device or the network device, which is not specifically limited in the present application.

The embodiments of the present application further provide a computer program. The computer program, when executed by a computer, causes the computer to execute the wireless communication method provided by the present application. Optionally, the computer program may be applied to the communication device in the embodiments of the present application, and the computer program, when executed on the computer, causes the computer to execute the corresponding processes implemented by the communication device in the various methods of the embodiments of the present application, which will not be repeated here for brevity. The communication device may be the terminal device or the network device, which is not specifically limited in the present application.

The embodiments of the present application further provide a communication system. The communication system may include the above-mentioned terminal device and the network device, to form the communication system 100 as shown in FIG. 1, which will not be repeated here for brevity. It should be noted that, the term “system”, etc., herein may also be called as a “network management architecture” or “network system”.

It should also be understood that, the terms used in the embodiments of the present application and the appended claims are for the purpose of describing embodiments only and are not intended to limit the embodiments of the present application. For example, singular forms “a/an”, “the”, “above/above-mentioned”, and “this”, as used in the embodiments of the present application and the appended claims, are intended to include plural forms as well, unless the context clearly represents other meanings.

Those skilled in the art may realize that, units and algorithm steps of the examples described in combination with the embodiments disclosed herein can be implemented in an electronic hardware or in a combination of a computer software and an electronic hardware. Whether these functions are performed by way of hardware or software depends on an application and a design constraint of the technical solution. A skilled person may use different methods for each application, to implement the described functions, but such implementation should not be considered beyond the scope of the embodiments of the present application. If they are implemented in a form of a software functional unit and sold or used as an independent product, they may be stored in a non-transitory computer readable storage medium. Based on this understanding, the technical solution of the embodiments of the present application essentially, or a part of the technical solution that contributes to the prior art, or a part of the technical solution, may be embodied in a form of a software product, and the computer software product is stored in a storage medium, and includes a plurality of instructions for enabling a computer device (which may be a personal computer, a server, or a network device, etc.) to perform all or some of steps of the methods described in the embodiments of the present application. And, the storage medium mentioned above includes a USB flash drive (U disk), a mobile hard disk, a read-only memory, a random access memory, a diskette, or an optical disk, and various mediums that may store program codes.

Those skilled in the art may also realize that, for convenience and simplicity of description, the working processes of the system, the apparatus and the unit described above may refer to the corresponding processes in the above method embodiments, which will not be repeated here. In several embodiments provided by the present application, it should be understood that the disclosed system, apparatus and method may be implemented in other ways. For example, the division of the units or modules or components in the apparatus embodiments described above is only a logical functional division, and in an actual implementation, there may be other division manners, for example, a plurality of units or modules or components are combined or integrated into another system, or some units or modules or components may be ignored or not executed. For another example, the units/modules/components illustrated above as separate/shown components may be or may not be physically separated, that is, they may be located in one place, or may be distributed onto multiple network units. A part or all of the units or modules or components may be selected according to actual needs to achieve the purpose of the embodiments of the present application. Finally, It needs to be noted that, the coupling or direct coupling or communicative connection between each other as shown or discussed above may be an indirect coupling or a communicative connection via some interfaces, apparatus or units, which may be electrical, mechanical, or in other forms.

The above content is only some implementations of the embodiments of the present application, but the protection scope of the embodiments of the present application is not limited thereto, and any skilled familiar with this technical field may easily think of changes or substitutions within the technical scope disclosed in the embodiments of the present application, which should be all covered within the protection scope of the embodiments of the present application. Therefore, the protection scope of the embodiments of the present application should be subject to the protection scope of the claims.

What is claimed is:

1. A wireless communication method, comprising:
performing a compression operation on a first data packet based on at least one compression protocol; wherein the at least one compression protocol comprises an uplink data compression (UDC) protocol.

2. The method according to claim 1, wherein a service data adaptation protocol (SDAP) header in the first data packet is not compressed; and/or, when the first data packet is an SDAP control protocol data unit (PDU), the SDAP control PDU is not compressed.

3. The method according to claim 1, wherein the first data packet is a PDCP service data unit (SDU).

4. The method according to claim 3, wherein the PDCP SDU comprises a SDAP control PDU, the SDAP control PDU is not compressed.

5. The method according to claim 1, wherein the UDC protocol is used to compress at least one of: an Internet protocol (IP) header, a payload, an Ethernet frame header, or a remaining portion of the first data packet except a packet header;
wherein a compressed packet of the first data packet comprises at least one of: a PDCP header, an SDAP header, a UDC header or a data block.

6. The method according to claim 5, wherein performing the compression operation on the first data packet based on the at least one compression protocol, comprises:
performing the compression operation on the first data packet based on the UDC protocol.

7. The method according to claim 1, wherein performing the compression operation on the first data packet based on the UDC protocol, comprises:
when at least one of the following is met, performing the compression operation on the first data packet based on the UDC protocol:
UDC configuration being configured;
the UDC configuration and the ROHC configuration being configured not simultaneously; or
the UDC configuration and the EHC configuration being configured not simultaneously;
or
performing the compression operation on the first data packet based on the UDC protocol, comprises:
when the compression operation is not performed on a service data adaptation protocol (SDAP) header in the first data packet, performing the compression operation on the first data packet based on the UDC protocol;
wherein a compressed packet of the first data packet comprises at least one of the following in sequence: a PDCP header, an SDAP header, a UDC header, or a data block.

8. The method according to claim 1, wherein the method further comprises:
receiving or transmitting UDC configuration, wherein the UDC configuration meets at least one of:
the UDC configuration being configured for a data radio bearer (DRB);
the UDC configuration being carried in packet data convergence protocol (PDCP) configuration;
the UDC configuration comprising at least one of a buffer size or a dictionary;
the UDC configuration being configured not simultaneously with at least one of the following configuration: EHC configuration, or ROHC configuration; or
the UDC configuration being configured not simultaneously with at least one of the following configuration: dual active protocol stack (DAPS) configuration, or out-of-order transmission configuration;
wherein the UDC configuration is configured when PDCP reestablishment configuration is configured.

9. The method according to claim 1, wherein performing the compression operation on the first data packet based on the at least one compression protocol, comprises:
performing the compression operation based on the UDC protocol, and generating a UDC packet;
wherein the UDC packet comprises a UDC header and a UDC data block.

10. The method according to claim 1, wherein the method is applicable for a terminal device.

11. A communication device, comprising:
a memory, configured to store a computer program; and
a processor, configured to invoke and execute the computer program stored in the memory;
wherein the processor is configured to perform:
performing a compression operation on a first data packet based on at least one compression protocol; wherein the at least one compression protocol comprises an uplink data compression (UDC) protocol.

12. The communication device according to claim 11, wherein a service data adaptation protocol (SDAP) header in the first data packet is not compressed; and/or, when the first data packet is an SDAP control protocol data unit (PDU), the SDAP control PDU is not compressed.

13. The communication device according to claim 11, wherein the first data packet is a PDCP service data unit (SDU); wherein
the PDCP SDU comprises a SDAP control PDU, the SDAP control PDU is not compressed.

14. The communication device according to claim 11, wherein the processor is further configured to perform:
when at least one of the following is met, performing the compression operation on the first data packet based on the UDC protocol:
UDC configuration being configured;
the UDC configuration and the ROHC configuration being configured not simultaneously; or
the UDC configuration and the EHC configuration being configured not simultaneously;
or
performing the compression operation on the first data packet based on the UDC protocol, comprises:
when the compression operation is not performed on a service data adaptation protocol (SDAP) header in the first data packet, performing the compression operation on the first data packet based on the UDC protocol;
wherein a compressed packet of the first data packet comprises at least one of the following in sequence: a PDCP header, an SDAP header, a UDC header, or a data block.

15. The communication device according to claim 11, wherein communication device further comprises a transceiver, the transceiver is configured to perform:
receiving or transmitting UDC configuration, wherein the UDC configuration meets at least one of:
the UDC configuration being configured for a data radio bearer (DRB);
the UDC configuration being carried in packet data convergence protocol (PDCP) configuration;
the UDC configuration comprising at least one of a buffer size or a dictionary;
the UDC configuration being configured not simultaneously with at least one of the following configuration: EHC configuration, or ROHC configuration; or
the UDC configuration being configured not simultaneously with at least one of the following configuration: dual active protocol stack (DAPS) configuration, or out-of-order transmission configuration; wherein
the UDC configuration is configured when PDCP reestablishment configuration is configured.

16. The communication device according to claim 11, wherein the processor is further configured to perform:
performing the compression operation based on the UDC protocol, and generating a UDC packet;
wherein the UDC packet comprises a UDC header and a UDC data block.

17. A chip, comprising a processor; wherein
the processor configured to invoke and execute a computer program from a memory, and the processor is configured to perform:
performing a compression operation on a first data packet based on at least one compression protocol; wherein the at least one compression protocol comprises an uplink data compression (UDC) protocol.

18. The chip according to claim 11, wherein a service data adaptation protocol (SDAP) header in the first data packet is not compressed; and/or, when the first data packet is an SDAP control protocol data unit (PDU), the SDAP control PDU is not compressed.

19. The chip according to claim 11, wherein the first data packet is a PDCP service data unit (SDU); wherein
the PDCP SDU comprises a SDAP control PDU, the SDAP control PDU is not compressed.

20. The chip according to claim 11, wherein the processor is further configured to perform:
when at least one of the following is met, performing the compression operation on the first data packet based on the UDC protocol:
UDC configuration being configured;
the UDC configuration and the ROHC configuration being configured not simultaneously; or
the UDC configuration and the EHC configuration being configured not simultaneously;
or
performing the compression operation on the first data packet based on the UDC protocol, comprises:
when the compression operation is not performed on a service data adaptation protocol (SDAP) header in the first data packet, performing the compression operation on the first data packet based on the UDC protocol;
wherein a compressed packet of the first data packet comprises at least one of the following in sequence: a PDCP header, an SDAP header, a UDC header, or a data block;
or
the processor is further configured to perform:
performing the compression operation based on the UDC protocol, and generating a UDC packet;
wherein the UDC packet comprises a UDC header and a UDC data block.
